(19) United States
(12) Patent Application Publication
(10) Pub. No.: US 2017/0269870 A1
(43) Pub. Date: Sep. 21, 2017

(54) MEMORY CONTROLLER, NONVOLATILE STORAGE DEVICE, NONVOLATILE STORAGE SYSTEM, AND MEMORY CONTROL METHOD

(71) Applicant: Panasonic Intellectual Property Management Co., Ltd., Osaka (JP)

(72) Inventors: Hirokazu SO, Kyoto (JP); Toshiyuki HONDA, Kyoto (JP)

(21) Appl. No.: 15/356,778

(22) Filed: Nov. 21, 2016

(30) Foreign Application Priority Data
Mar. 17, 2016 (JP) 2016-053353

(51) Int. Cl. G06F 3/06; G06F 12/1009

(52) U.S. Cl. CPC G06F 3/0652; G06F 3/0608; G06F 3/0679; G06F 3/064; G06F 12/1009; G06F 2212/1016; G06F 2212/202; G06F 2212/657

(57) ABSTRACT

A memory controller controls a nonvolatile memory having physical blocks. The memory controller includes a control unit and a host interface unit. The control unit writes data into a physical block. The host interface unit receives and transmits data from and to the external device. The control unit manages first vacant blocks and second vacant blocks based on a physical-block management table for managing states of the physical blocks. The first vacant block can be used in garbage collection processing of arranging data stored in the nonvolatile memory. The second vacant block cannot be used in garbage collection processing. The control unit increases a quantity of the second vacant blocks when the control unit does not receive an instruction from the external device. The control unit writes data into the second vacant blocks when the control unit receives an instruction for writing data from the external device.

### BACKGROUND

1. Technical Field

The present disclosure relates to a memory controller that controls a data-rewritable nonvolatile memory and also relates to a nonvolatile storage device, a nonvolatile storage system, and a memory control method.

2. Related Art

Conventionally, in a semiconductor storage device that includes a plurality of physical blocks each as a data erasure unit, there is known a method called garbage collection for generating an available physical block by arranging data when available physical blocks are exhausted. When garbage collection processing is executed by the nonvolatile storage device during data writing from a host device to a nonvolatile storage device, a data writing speed decreases considerably.

JP 2014-132505 A discloses a memory system that carries out garbage collection. The memory system disclosed in JP 2014-132505 A determines a setting value of a transfer speed based on a balance between a speed of generating a vacant block by garbage collection and a speed of consuming a vacant block by data writing. In this case, a situation that a command from the host device is extremely waited can be suppressed more than a case where processing relevant to transfer to the host device is stopped until completion of garbage collection.

### SUMMARY

The present disclosure provides a memory controller, a nonvolatile storage device, a nonvolatile storage system, and a memory control method, capable of writing a predetermined quantity of data from a host device with priority.

A memory controller according to one aspect of the present disclosure is a memory controller that controls a nonvolatile memory having a plurality of physical blocks. The memory controller includes a control unit and a host interface unit. The control unit writes data into a physical block. The host interface unit is connected to an external device, and receives and transmits data from and to the external device. The control unit manages first vacant blocks and second vacant blocks based on a physical-block management table for managing states of the plurality of physical blocks. The first vacant block is a physical block that can be used in garbage collection processing of arranging data stored in the nonvolatile memory. The second vacant block is a physical block that cannot be used in garbage collection processing. The control unit increases a quantity of the second vacant blocks when the control unit does not receive an instruction from the external device. The control unit writes data into the second vacant blocks when the control unit receives an instruction for writing data from the external device.

A nonvolatile storage device according to one aspect of the present disclosure includes the memory controller and the nonvolatile memory. The nonvolatile memory is connected to the memory controller, and stores data written by the memory controller.

A nonvolatile storage system according to one aspect of the present disclosure includes the memory controller, the nonvolatile memory, and an external device. The external device connects to the memory controller, and transmits an instruction to the memory controller for writing data into the nonvolatile memory.

A memory control method according to one aspect of the present disclosure is a method for controlling the nonvolatile memory having the plurality of physical blocks by the memory controller.

The memory controller, the nonvolatile storage device, the nonvolatile storage system, and the memory control method in the present disclosure enable writing of the predetermined quantity of data from the host device with priority.

### BRIEF DESCRIPTION OF DRAWINGS

FIG. 1 is a diagram showing a configuration of a nonvolatile storage system according to a first embodiment.

FIG. 2 is a diagram showing a configuration of a logical-physical translation table according to the first embodiment.

FIG. 3 is a diagram showing a configuration of a physical-block management table according to the first embodiment.

FIG. 4 is a diagram showing a configuration of priority-writing quantity information according to the first embodiment.

FIG. 5 is a diagram showing a configuration of physical blocks as recording regions of a nonvolatile memory according to the first embodiment.

FIG. 6 is a diagram showing a configuration of physical pages in the physical block according to the first embodiment.

FIG. 7 is a diagram showing a configuration of a host device according to the first embodiment.

FIG. 8 is a flowchart showing an operation of a nonvolatile storage device after a power source is turned on according to the first embodiment.

FIG. 9 is a flowchart showing a data writing operation of the nonvolatile storage device according to the first embodiment.

FIG. 10 is a diagram showing an example of a logical-physical translation table after step S905.

FIG. 11 is a diagram showing an example of a physical-block management table after step S905.

FIG. 12 is a diagram showing an example of priority-writing quantity information after step S905.

FIG. 13 is a diagram showing an operation example of garbage collection in step S908.

FIG. 14 is a diagram showing an example of a logical-physical translation table after step S908.

FIG. 15 is a diagram showing an example of a physical-block management table after step S908.

FIG. 16 is a diagram showing an example of a logical-physical translation table after step S909.

FIG. 17 is a diagram showing an example of a physical-block management table after step S909.

FIG. 18 is a flowchart showing priority-writing-quantity increasing processing of the nonvolatile storage device according to the first embodiment.

FIG. 19 is a diagram showing an example of a logical-physical translation table after step S1002.

FIG. 20 is a diagram showing an example of priority-writing quantity information after step S1002.

FIG. 21 is a flowchart illustrating garbage collection processing in step S1003.

FIG. 22 is a flowchart showing a priority-writing-quantity acquiring operation of the nonvolatile storage device according to the first embodiment.

FIG. 23 is a flowchart showing a priority-writing-quantity setting operation of the nonvolatile storage device according to the first embodiment.

FIG. 24 is a diagram showing an example of priority-writing quantity information after step S2202.

FIG. 25 is a flowchart showing an operation of a host device after a power source is turned on according to the first embodiment.

### DESCRIPTION OF EMBODIMENTS

Hereinafter, embodiments will be described in detail by appropriately referring to the drawings. However, a description which is more than necessary will be omitted in some cases. For example, a detailed description of already known matters and a redundant description of substantially the same configuration will be omitted in some cases. The omission is carried out to facilitate the understanding of those skilled in the art, by avoiding the following descriptions becoming unnecessarily redundant.

The appended drawings and the following descriptions are provided for those skilled in the art to sufficiently understand the present disclosure. The appended drawings and the following descriptions are not intended to limit the subject described in claims.

### First Embodiment

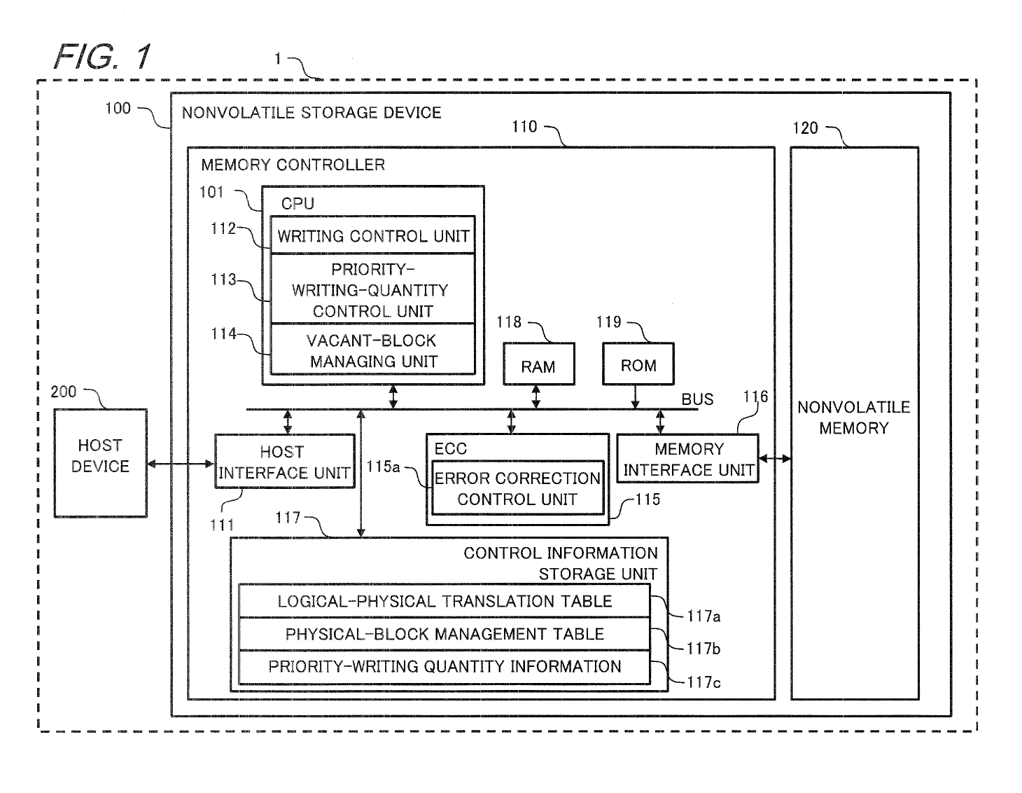

Hereinafter, a first embodiment will be described with reference to FIGS. 1 to 25.

### [1-1. Configuration]

### [1-1-1. Configuration of Nonvolatile Storage System]

FIG. 1 is a diagram showing a configuration of a nonvolatile storage system according to the present embodiment. In FIG. 1, a nonvolatile storage system 1 includes a nonvolatile storage device 100, and a host device 200 as a higher-level device.

The nonvolatile storage device 100 is a solid state drive (SSD) as a semiconductor memory device, for example. Alternatively, the nonvolatile storage device 100 may be a secure digital (SD) memory card, a CaompactFlash (registered tradename), a flash drive, or a memory device for incorporation. The nonvolatile storage device 100 can store digital data of various contents such as motion pictures, still pictures, sound, and texts (hereinafter referred to as “content data”). The nonvolatile storage device 100 can be connected to the host device 200 as a higher-level device. The host device 200 is an example of an external device.

The nonvolatile storage device 100 includes a memory controller 110 and a nonvolatile memory 120, as shown in FIG. 1.

The host device 200 records content data into the nonvolatile storage device 100, and reads content data from the nonvolatile storage device 100. The host device 200 is an electronic device such as a digital camera, a personal computer, a smartphone, a tablet terminal, or a television.

The nonvolatile memory 120 is a recording element that can hold content data even in a state of no power supply. The nonvolatile memory 120 is configured with a NAND flash memory, for example.

### [1-1-2. Configuration of Memory Controller]

Next, a configuration of the memory controller 110 of the nonvolatile storage device 100 will be described in detail. The memory controller 110 receives a command from the host device 200, and in accordance with the command, controls writing of content data to the nonvolatile memory 120 and reading from the nonvolatile memory 120.

The memory controller 110 includes a central processing unit (CPU) 101 as a control unit or a processor, a host interface unit 111, an error correcting code (ECC) circuit 115, a memory interface unit 116, a control information storage unit 117, a random access memory (RAM) 118, and a read only memory (RCM) 119, which are connected each other via a bus.

The CPU 101 is a computing unit that executes various programs.

The host interface unit 111 is an interface that carries out transmission and reception of data such as a command and content data between the host device 200 and the nonvolatile storage device 100 by the control of the CPU 101.

The memory interface unit 116 is an interface that controls writing, reading, and erasing of data to and from the nonvolatile memory 120 by the control of the CPU 101.

The ECC circuit 115 is an error correcting circuit that carries out encoding processing of data to be stored and decoding processing of stored data. An error correction control unit 115a that functions based on the ECC circuit 115 corrects an error generated in the content data written in the nonvolatile memory 120.

The control information storage unit 117 is a memory that stores control information processed by the CPU 101 and management information of the nonvolatile memory 120. The control information storage unit 117 is configured with a NAND flash memory, for example.

The RAM 118 is used as a storage area and a working region of programs that are executed by the processing of the CPU 101 and parameters that change from time to time in the program processing.

The ROM 119 stores a program executed by the CPU 101, or fixed data as an operation parameter.

The CPU 101 makes function the writing control unit 112, a reading control unit (not shown), the priority-writing-quantity control unit 113, and the vacant-block managing unit 114.

The writing control unit 112 carries out control for writing content data, received by the host interface unit 111, into the nonvolatile memory 120.

The reading control unit (not shown) controls to output content data stored in the nonvolatile memory 120 to the host device 200 via the host interface unit 111.

The priority-writing-quantity control unit 113 controls a priority-writing quantity. The priority-writing quantity is a quantity of data that the nonvolatile storage device 100 writes from the host device 200 with priority. As will be discussed later in detail, when the host device 200 has written data in a size equal to or smaller than a value indicated by a present priority-writing quantity (priority-writing-quantity present value 308), the nonvolatile storage device 100 executes writing with priority from the host device 200, without carrying out garbage collection processing.

The vacant-block managing unit 114 manages the physical block 121 in the nonvolatile memory 120, and generates a vacant physical block 121 that becomes necessary to write content data received by the host interface unit 111 into the nonvolatile memory 120. Hereinafter, a vacant physical block in a data writable state will be referred to as a “vacant block”.

The control information storage unit 117 constitutes a storage region for storing a logical-physical translation table 117a, a physical-block management table 117b, and priority-writing quantity information 117c. The above information 117a, 117b, 117c stored in the control information storage unit 117 will be described later.

The control information storage unit 117 may be provided on not the memory controller 110 but on the nonvolatile memory 120, or may be provided on a dynamic random access memory (DRAM) which is prepared to be accessible from the memory controller 110.

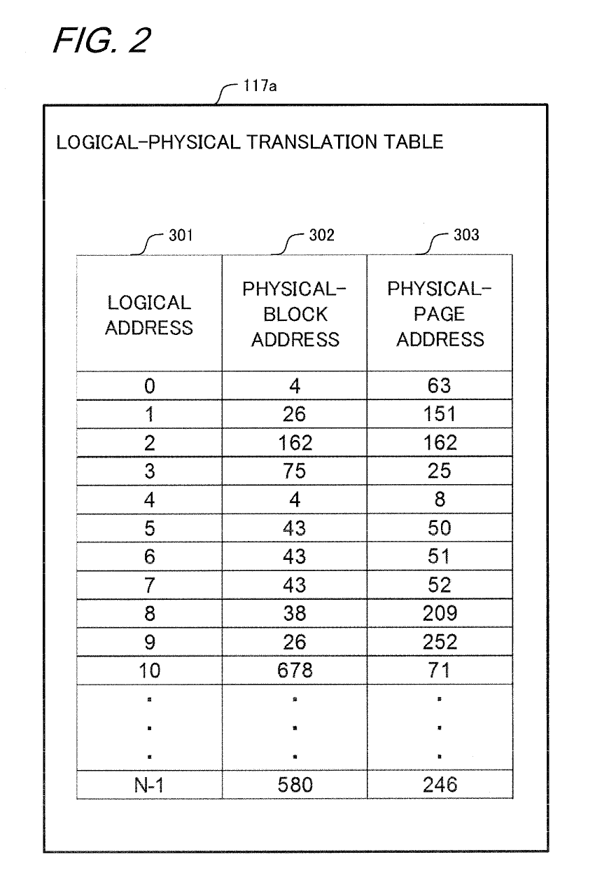

FIG. 2 is a diagram showing a configuration of the logical-physical translation table 117a according to the present embodiment. The logical-physical translation table 117a is a data table for managing a relationship between a logical address assigned by the external device such as the host device 200 and a physical block in the nonvolatile memory 120. The logical-physical translation table 117a stores information indicating a relationship between a logical address 301 used by the host device 200 and a physical address of the nonvolatile memory 120, that is, a physical-block address 302 and a physical-page address 303.

In FIG. 2, the logical-physical translation table 117a correlates a physical-block address “4” and a physical-page address “63” with a logical address “0”, and correlates a physical-block address “26” and a physical-page address “151” with a logical address “1”. The logical-physical translation table 117a similarly stores a correlation between a physical-block address and a physical page-address with regard to a logical address “2” and logical addresses after the logical address “2”. In the present embodiment, it is assumed that one physical block is configured with 256 physical pages as described in detail later.

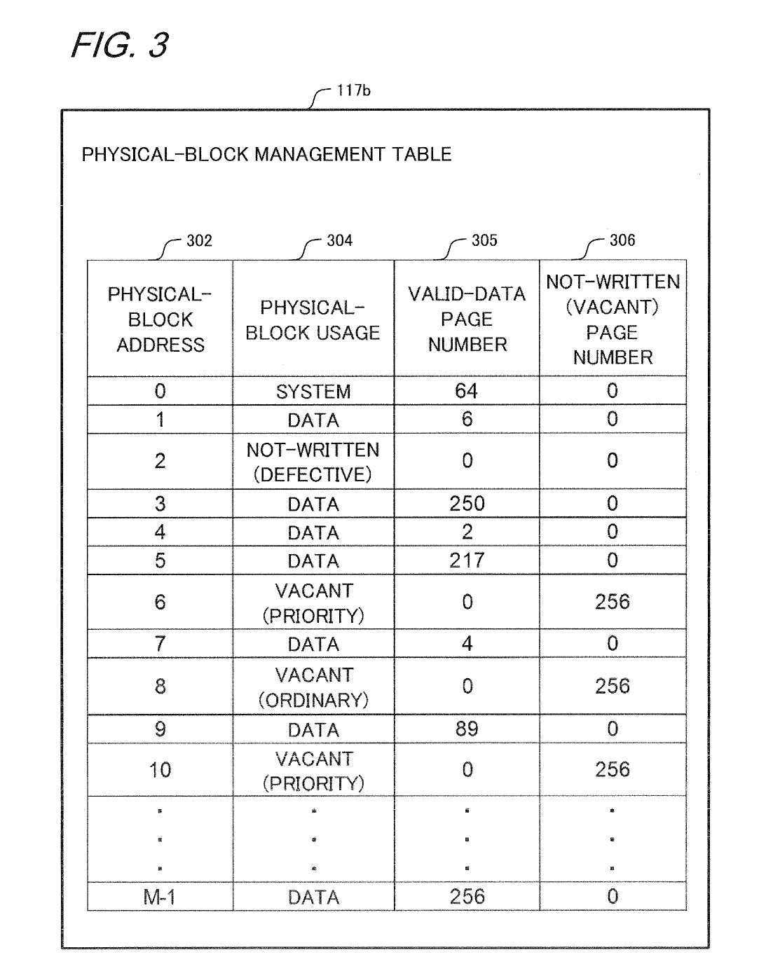

FIG. 3 is a diagram showing a configuration of the physical-block management table 117b according to the present embodiment. The physical-block management table 117b is a data table for managing states of a plurality of physical blocks in the nonvolatile memory 120. In order to manage a using state of each physical block constituting the nonvolatile memory 120, the physical-block management table 117b stores a correlation among the physical-block address 302, a physical-block usage 304, a valid-data page number 305, and a not-written (vacant) page number 306.

In FIG. 3, the physical-block usage 304 stores various usages for each of physical blocks specified by the physical-block address 302. The various usages include “system”, “data”, “not-written (defective)”, “vacant (ordinary)”, “vacant (priority)”, “in-writing”, and the like. Hereinafter, each usage stored in the physical-block usage 304 will be described.

The “system” indicates that the physical block stores system information which is managed internally in the nonvolatile storage device 100. The system information includes various kinds of parameter information, programs loaded on the RAM 118, information loaded on the control information storage unit 117 relevant to the logical-physical translation table 117a, the physical-block management table 117b, and the priority-writing quantity information 117c, and the like.

The “data” indicates that data written by the host device 200 is stored in at least a part of a physical page of the physical block.

The “not-written (defective)” indicates that the physical block is a congenital or postnatal defective block and is not used for data storage.

The “vacant (ordinary)” indicates that the physical block is a vacant (not used) block which can be used for new data writing from the host device 200 and for data writing in garbage collection processing. Hereinafter, a vacant block of which the physical-block usage 304 is managed as “vacant (ordinary)” will be referred to as an “ordinary vacant block”. The ordinary vacant blocks are an example of first vacant blocks that can be used in garbage collection processing and in writing data from the external device.

The “vacant (priority)” indicates that the physical block is a vacant (not used) block which is reserved for writing new data from the host device 200 with priority. Hereinafter, a vacant block of which the physical-block usage 304 is managed as “vacant (priority)” will be referred to as a “priority-writing vacant block”. The priority-writing vacant blocks are an example of second vacant blocks that cannot be used in garbage collection processing but can be used in data writing from the external device.

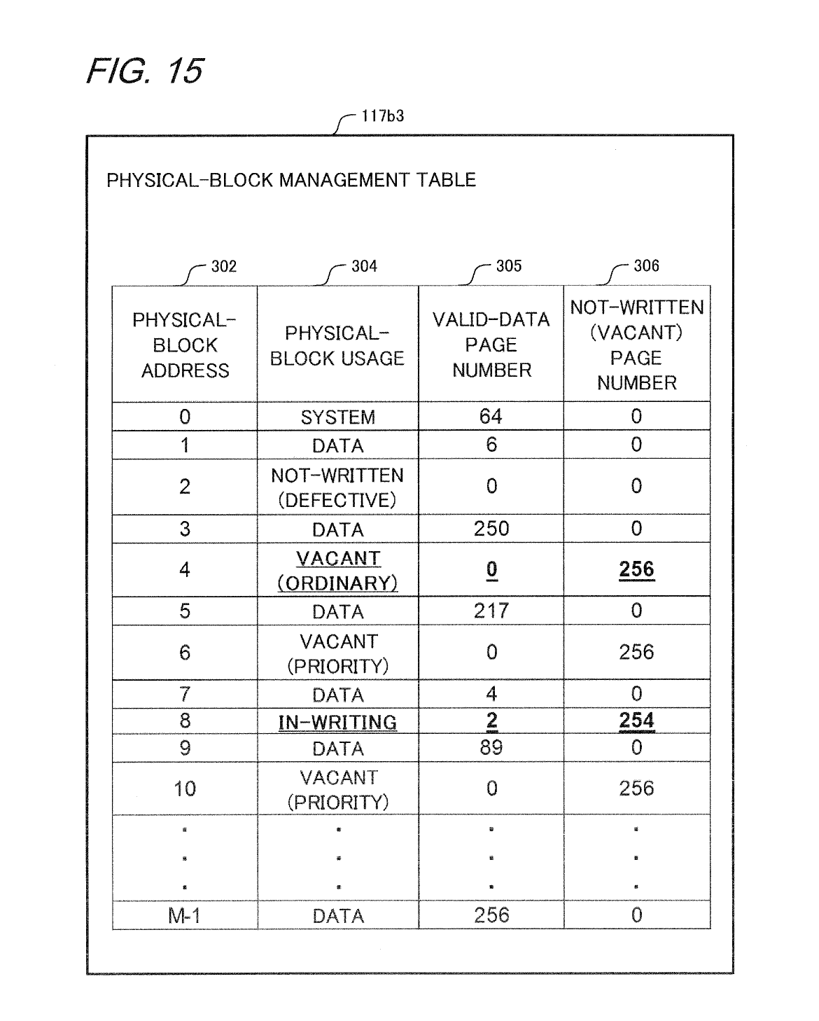

The “in-writing” (refer to FIG. 15) indicates that data written by the host device 200 is stored in a part of a physical page of the physical block and that another physical page can be used in new data writing from the host device 200.

In FIG. 3, when the physical-block usage 304 of a physical block specified in the physical-block address 302 is “system” or “data”, the valid-data page number 305 stores a number of pages in which valid data exists out of physical pages included in the physical block. When the physical-block usage 304 is “system”, the valid data indicates system information. When the physical-block usage 304 is “data”, the valid data indicates latest data out of data written into the same logical address by the host device 200. For example, in a case where the host device 200 has written data at three times into the same logical address, only the data written at the third time is valid data. In this case, data written at the first time and the second time are not valid data, that is, are invalid data.

In FIG. 3, the not-written (vacant) page number 306 stores a number of not-written physical pages in each of the physical block specified by the physical-block address 302.

According to the physical-block management table 117b in FIG. 3, “system” of the physical-block usage 304, “64” of the valid-data page number 305, and “0” of the not-written (vacant) page number 306 are correlated with “0” of the physical-block address 302. Consequently, it can be understood that the physical block of the physical-block address “0” has a valid-data page number “64” and a not-written (vacant) page number “0”, and that invalid data is recorded in 192 (=256-0-64) pages, out of a total number of pages 256.

Further, in the physical-block management table 117b, physical-block usage “data”, a valid-data page number “6”, and a not-written (vacant) page number “0” are correlated with a physical-block address “1”. For a physical-block address “2” and after the physical-block address “2”, information of a physical-block usage, a valid-data page number, and a not-written (vacant) page number is similarly stored while being correlated with one another.

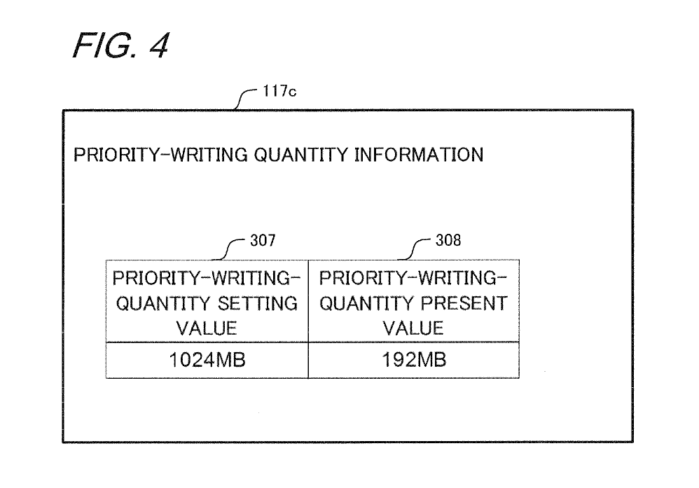

FIG. 4 is a diagram showing a configuration of the priority-writing quantity information 117c according to the present embodiment. The priority-writing quantity information 117c is information for managing a priority-writing quantity by which writing from the external device such as the host device 200 can be carried out with priority. The priority-writing quantity information 117c stores a priority-writing-quantity setting value 307 indicating a priority-writing quantity that the nonvolatile storage device 100 should secure and a priority-writing-quantity present value 308 indicating a priority-writing quantity that the nonvolatile storage device 100 secures at present.

In FIG. 4, the priority-writing quantity information 117c indicates that the priority-writing-quantity setting value 307 is “1024 MB” and the priority-writing-quantity present value 308 is “192 MB”, as an example.

### [1-1-3. Configuration of Nonvolatile Memory]

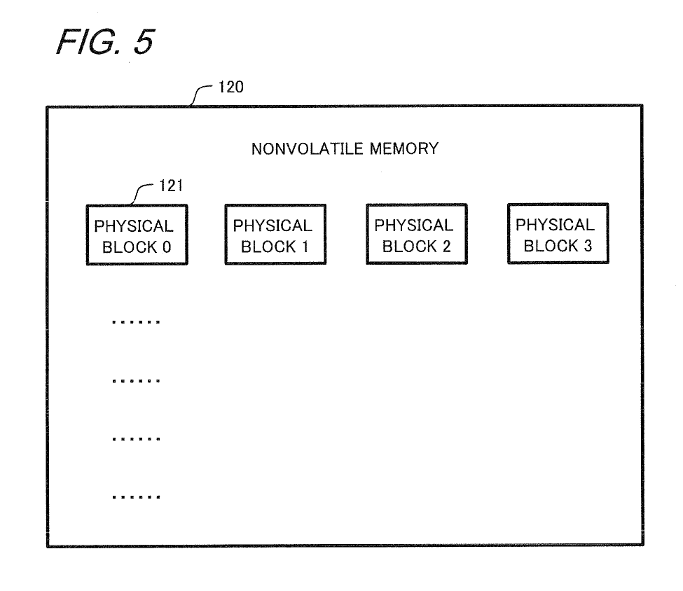

Next, a configuration of the nonvolatile memory 120 of the nonvolatile storage device 100 will be described. FIG. 5 is a diagram showing a configuration of physical blocks as recording regions of the nonvolatile memory 120 according to the present embodiment.

The nonvolatile memory 120 is configured with a plurality of physical blocks 121. The physical block 121 is an erasure unit in the nonvolatile memory 120, so that data erasing is executed in this unit.

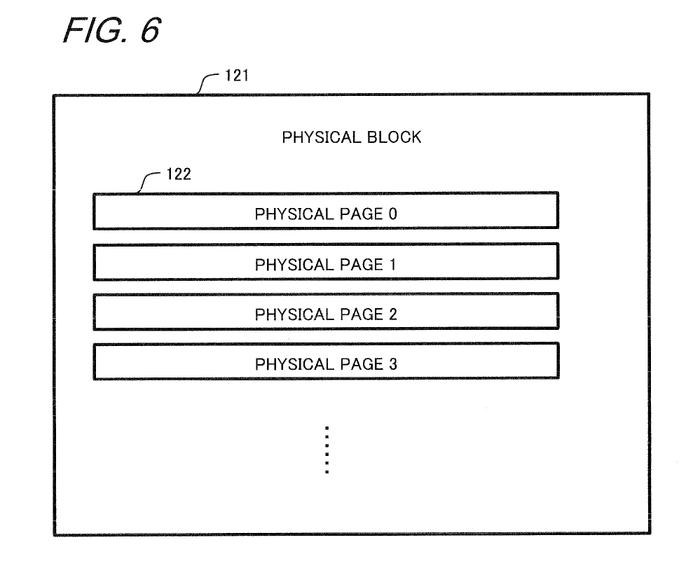

FIG. 6 is a diagram showing a configuration of the physical block 121 according to the present embodiment.

The physical block 121 is configured with a plurality of physical pages 122. The physical page 122 is a writing unit of data to the physical block 121. However, data cannot be further written into the physical page 122 in which data is already written, that is, overwriting cannot be carried out. Therefore, in order to overwrite data in the physical page 122 in which data is already written, it is necessary to erase the data in the unit of the physical block 121 including the physical page 122 of a writing destination in advance, and then the data needs to be written.

In the present embodiment, it is assumed that, in the nonvolatile memory 120, one unit of the physical page is 16 kB and that one unit of the physical block is 4 MB (that is, 16 kB×256 pages).

### [1-1-4. Configuration of Host Device]

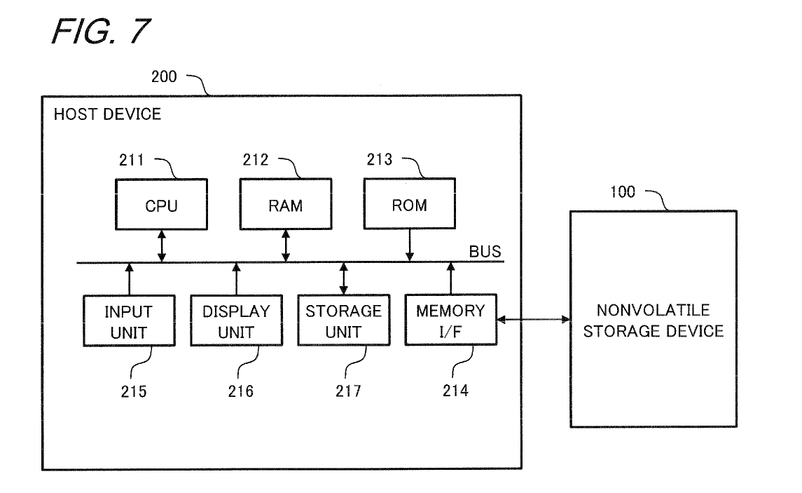

Next, a configuration of the host device 200 will be described. FIG. 7 is a configuration diagram showing the host device 200 according to the present embodiment.

The host device 200 is a device that can connect to the nonvolatile storage device 100.

The host device 200 includes a CPU 211, a RAM 212, a ROM 213, and a memory interface unit 214, which are connected to each other via a bus. The host device 200 also includes an input unit 215, a display unit 216, and a storage unit 217, which are connected to each other via the bus via a predetermined interface.

The CPU 211 is a computing unit that executes various application programs.

The RAM 212 is used as a storage area and a working region of programs executed in the processing of the CPU 211 and parameters that change from time to time in the program processing.

The ROM 213 stores a program executed by the CPU 211, and fixed data as an operation parameter.

The memory interface unit 214 is an interface that transmits and receives data such as a command and content data, to and from the nonvolatile storage device 100, by the control of the CPU 211.

The input unit 215 includes keys, buttons, a touch panel, a mouse, a keyboard, and the like that are operated by the user to input various commands to the CPU 211.

The display unit 216 is a liquid-crystal display, or an organic electroluminescence (EL) display, for example, that displays various kinds of information by texts or images.

The storage unit 217 has a flash memory or a hard disc, for example, as an information storage medium.

### [1-2. Operation]

An operation of the nonvolatile storage system 1 configured as described above will be described below.

### [1-2-1. Overview of Operation]

First, an overview of the operation of the nonvolatile storage system 1 according to the present embodiment will be described.

According to a conventional nonvolatile storage system, a generation timing of garbage collection processing in a nonvolatile storage device cannot be controlled from a host device side. Therefore, garbage collection processing is executed in the nonvolatile storage device upon writing content data from the host device, and a data writing speed decreases considerably in same cases.

Meanwhile, according to the present embodiment, the memory controller 110 of the nonvolatile storage device 100 manages the ordinary vacant blocks and the priority-writing vacant blocks, and realizes priority-writing of writing data from the host device 200 with priority over garbage collection processing. Further, the priority-writing-quantity control unit 113 enables the host device 200 to acquire and set the priority-writing quantity, that is, a quantity of data writing without executing garbage collection processing.

Specifically, the memory controller 110 executes processing to increase a quantity of priority-writing vacant blocks to a quantity (the priority-writing-quantity setting value 307) set by the host device 200 in advance, while there is no command reception from the host device 200. When the memory controller 110 has received a data writing command from the host device 200, the memory controller 110 writes data at a high speed without executing garbage collection processing as an upper limit is the priority-writing-quantity present value 308 secured in advance.

Hereinafter, a detail of the operation of the nonvolatile storage system 1 according to the present embodiment will be described.

### [1-2-2. Operation of Nonvolatile Storage Device]

An operation of the nonvolatile storage device 100 in the nonvolatile storage system 1 will be described below.

[1-2-2-1. Operation after Power-On]

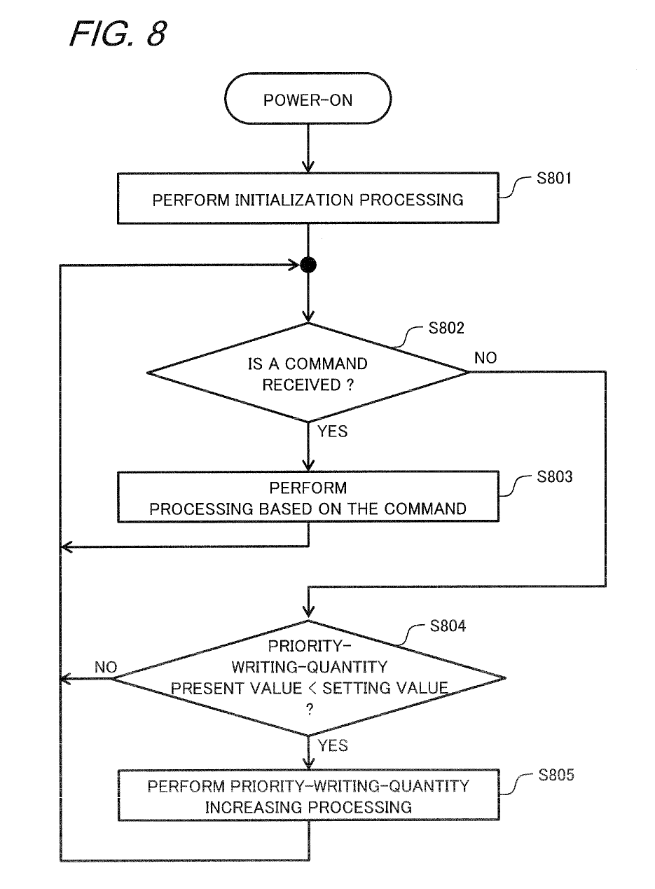

First, the operation of the nonvolatile storage device 100 after the power source is turned on will be described with reference to FIG. 8.

FIG. 8 is a flowchart showing the operation of the nonvolatile storage device 100 after the power-on according to the present embodiment.

The operation of the flowchart in FIG. 8 is started by turning on the power source of the nonvolatile storage device 100 before the host device 200 writes or reads content data to or from the nonvolatile storage device 100.

(Step S801) First, the nonvolatile storage device 100 initializes the memory controller 110 after the power source is turned on (S801). Specifically, the CPU 101 of the memory controller 110 executes a program stored in the ROM 119, carries out initialization processing to access the nonvolatile memory 120, reads system information stored in the nonvolatile memory 120, loads a program onto the RAM 118, and sets information to the control information storage unit 117. Based on the initialization processing in step S801, the memory controller 110 becomes in a state in which the memory controller 110 can receive various commands from the host device 200.
(Step S802) Next, the memory controller 110 checks whether the memory controller 110 has received a command from the host device 200 (S802). In the memory controller 110, the CPU 101 checks a reception state, in the host interface unit 111, of a command from the host device 200.
(Step S803) When the memory controller 110 has received a command from the host device 200 (Yes in S802), the memory controller 110 checks a kind of the received command, and executes processing according to the kind of the command (S803). The various commands include a data writing command, a priority-writing-quantity acquiring command, and a priority-writing-quantity setting command, for example. Processing according to the various commands will be described later. The memory controller 110 returns to step S802, after executing the processing of step S803.
(Step S804) On the other hand, when the memory controller 110 does not receive a command from the host device 200 (No in S802), the memory controller 110 refers to the priority-writing quantity information 117c of the control information storage unit 117, and determines whether the priority-writing-quantity present value 308 is smaller than the priority-writing-quantity setting value 307 (S804). When the priority-writing-quantity present value 308 is equal to or larger than the priority-writing-quantity setting value 307 (No in S804), the memory controller 110 returns to step S802.
(Step S805) When the priority-writing-quantity present value 308 is smaller than the priority-writing-quantity setting value 307 (Yes in S804), the memory controller 110 executes the priority-writing-quantity increasing processing (S805). The priority-writing-quantity increasing processing is processing carried out by the memory controller 110 of the nonvolatile storage device 100 to increase the quantity of priority-writing vacant blocks in the nonvolatile memory 120. A detail of the priority-writing-quantity increasing processing will be described later. The memory controller 110 returns to step S802, after executing the processing of step S805.

The memory controller 110 repeatedly executes the processing of step S802 and following steps in a predetermined cycle, for example.

According to the above processing, during a period when the memory controller 110 of the nonvolatile storage device 100 is not receiving a command from the host device 200, the memory controller 110 increases the quantity of priority-writing vacant blocks until the priority-writing-quantity present value 308 reaches the priority-writing-quantity setting value 307 (S805). Consequently, the nonvolatile storage device 100 can secure priority-writing vacant blocks to be used when the memory controller 110 has received a data writing command from the host device 200.

### [1-2-2-2. Data Writing Operation]

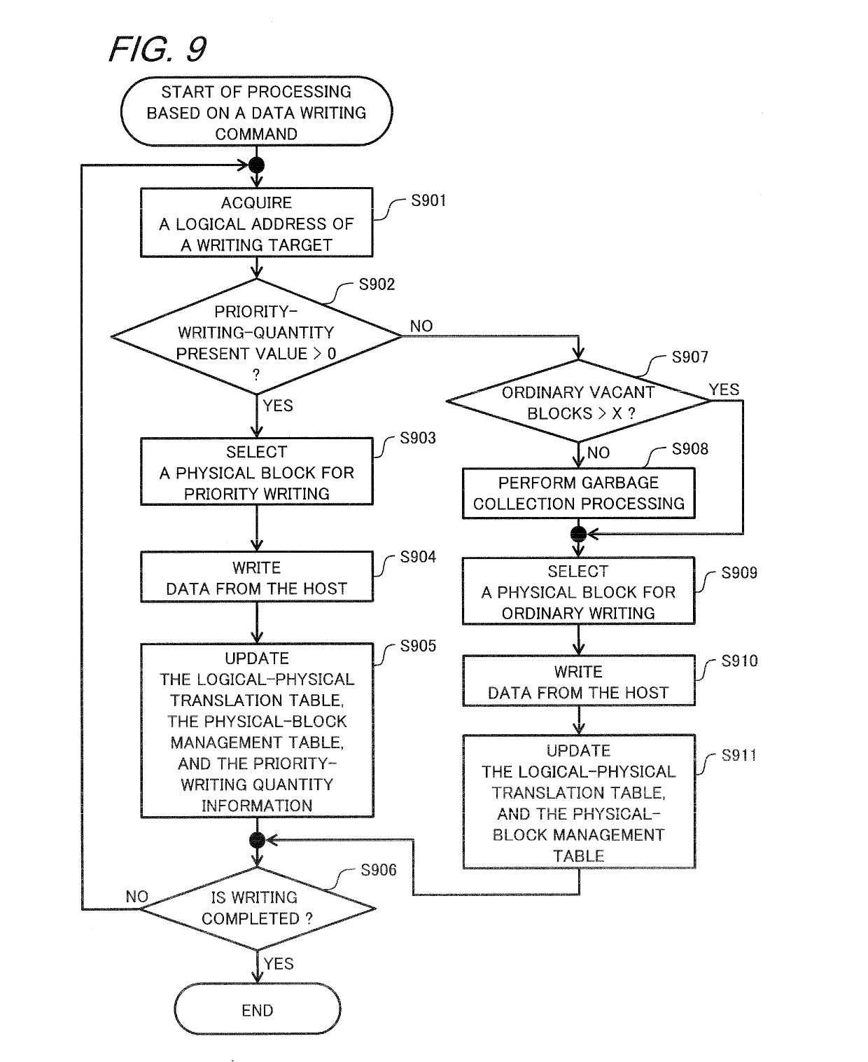

Next, a data writing operation will be described with reference to FIGS. 9 to 17, which the nonvolatile storage device 100 carries out, in step S803 in FIG. 8, based on a data writing command from the host device 200.

FIG. 9 is a flowchart showing the data writing operation of the nonvolatile storage device 100 according to the present embodiment.

The operation of the present flowchart is started when, in step S802 in FIG. 8, the memory controller 110 of the nonvolatile storage device 100 receives the data writing command from the host device 200. The host device 200 issues the data writing command at the time of writing content data into the nonvolatile storage device 100. The data writing command is for notifying the memory controller 110 of a data writing instruction from the host device 200 by assigning a writing address.

In the following description, it is assumed that, at a starting time of the operation of the present flowchart, the logical-physical translation table 117a is in the state shown in FIG. 2, the physical-block management table 117b is in the state shown in FIG. 3, and the priority-writing quantity information 117c is in the state shown in FIG. 4.

(Step S901) First, the memory controller 110 acquires a logical address of a writing target by the data writing command from the host device 200 (S901). The host interface unit 111 of the memory controller 110 receives the data writing command and the logical address of the writing destination. The CPU 101 of the memory controller 110 acquires each piece of information received from the host interface unit 111.

Hereinafter, as an example, an operation example that the logical address of the writing destination includes 256 segments from “9” to “265” will be described. Further, in the present embodiment, one segment of a logical address is 16 kB, and data of one logical address goes in one physical page.

(Step S902) Next, in the CPU 101, the priority-writing-quantity control unit 113 refers to the priority-writing quantity information 117c of the control information storage unit 117, and determines whether the priority-writing-quantity present value 308 is larger than 0 (S902). In the present embodiment, when the process proceeds to “Yes” in step S902, priority-writing of data from the host device 200 is carried out (steps S903 to S905). On the other hand, when the process proceeds to “No” in step S902, ordinary writing is carried out (steps S907 to S911). Hereinafter, each of the priority-writing and the ordinary writing by the memory controller 110 will be described.

### (1) Priority-Writing

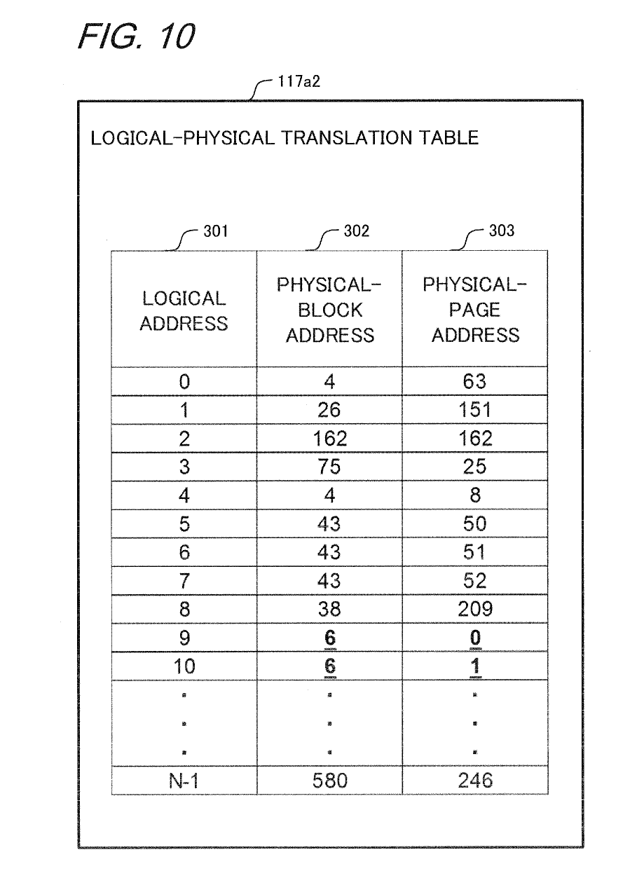

(Step S903) When the priority-writing-quantity present value 308 is larger than 0 (Yes in S902), the vacant-block managing unit 114 of the CPU 101 selects one priority-writing vacant block as a physical block of the writing destination (S903). The vacant-block managing unit 114 refers to the physical-block management table 117b of the control information storage unit 117, selects one of physical blocks of which the physical-block usage 304 is “vacant (priority)”, and erases this physical block. Hereinafter, there will be described an operation example that a physical block of the physical-block address “6” is selected from the physical-block management table 117b in the state shown in FIG. 3.
(Step S904) Next, in the CPU 101, the writing control unit 112 writes the writing data from the host device 200 received via the host interface unit 111, into the vacant block selected in step S903 (S904). In the present example, based on reception of the logical address of 256 segments in step S901, the writing control unit 112 writes 4 MB in 16 kB×256 segments, into the physical block of the physical-block address “6” selected in step S903, that is, the writing control unit 112 writes data of the same size as the size of the physical block.
(Step S905) Next, in the CPU 101, the writing control unit 112 updates the logical-physical translation table 117a, the physical-block management table 117b, and the priority-writing quantity information 117c of the control information storage unit 117, following the writing in step S904 (S905). FIGS. 10 to 12 illustrate the information updated in step S905.

FIG. 10 shows an example of a logical-physical translation table 117a2 updated from the state shown in FIG. 2. In the updated logical-physical translation table 117a2 illustrated in FIG. 10, the physical-page addresses “0”, “1”, and subsequent addresses of the physical-block address “6” written in step S904 are updated to be correlated with the logical addresses “9”, “10”, and subsequent addresses received in step S901.

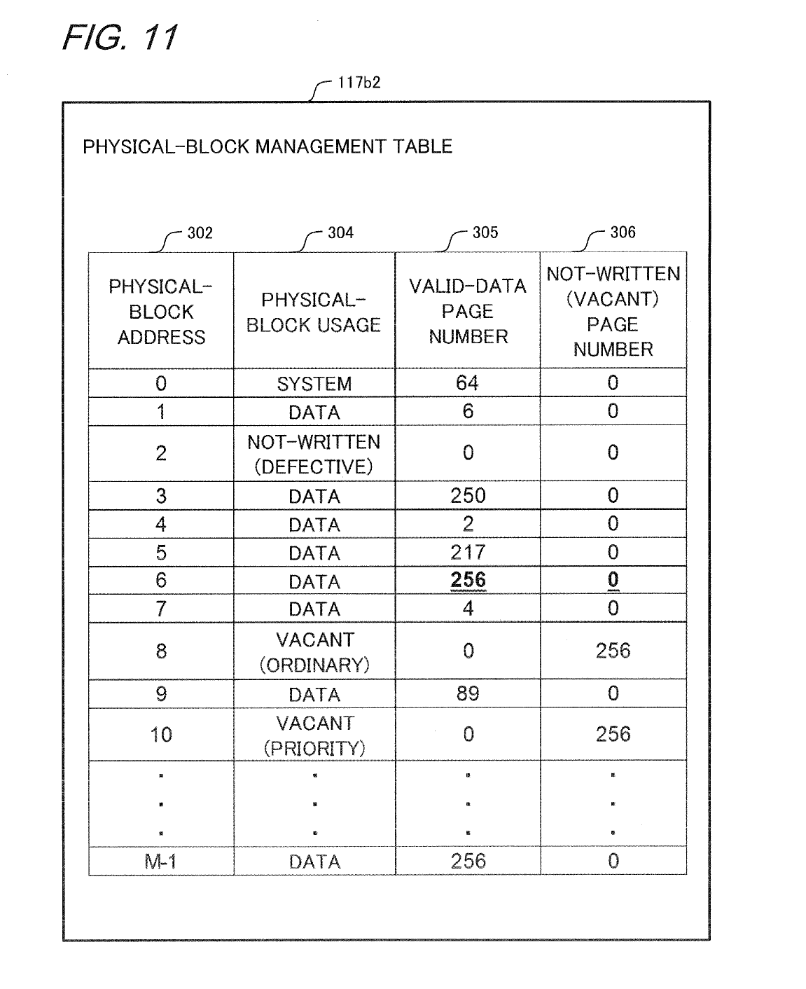

FIG. 11 shows an example of a physical-block management table 117b2 updated from the state shown in FIG. 3. In the updated physical-block management table 117b2 illustrated in FIG. 11, regarding the physical-block address “6” written in step S904, the physical-block usage 304 is updated from “vacant (priority)” to “data”, and the valid-data page number 305 is updated from “0” to “256”.

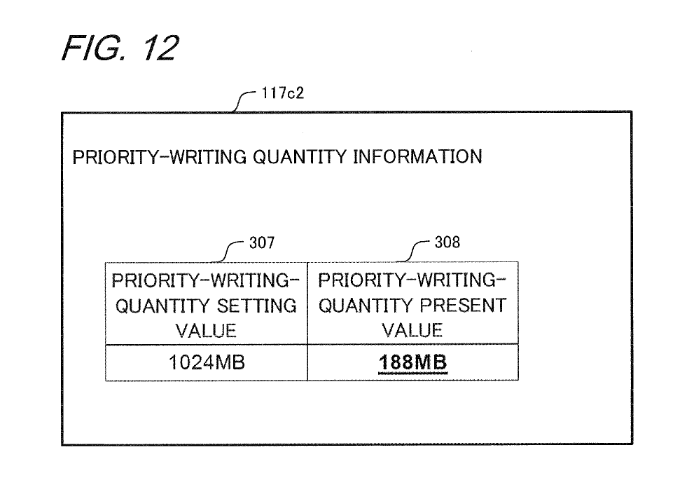

FIG. 12 shows an example of priority-writing quantity information 117c2 updated from the state shown in FIG. 4. In the updated priority-writing quantity information 117c2 illustrated in FIG. 12, the value of the priority-writing-quantity present value 308 is updated to “188 MB”, which is reduced an amount of the data size (4 MB) written in step S904.

(Step S906) Referring back to FIG. 9, in the CPU 101, the writing control unit 112 then determines whether writing to all writing addresses assigned from the host device 200 is ccmpleted (S906). When the writing is completed (Yes in S906), the writing control unit 112 ends the processing based on the data writing command.

On the other hand, when addresses to be written still remain (No in S906), the writing control unit 112 returns to the processing of step S901 in order to carry out the processing on the remaining addresses. For example, based on total assigned writing addresses and a writing-completed range, the CPU 101 acquires a logical address corresponding to one physical block within the remaining writing addresses (S901), and carries out processing of step S901 and following steps in a physical block unit.

### (2) Ordinary Writing

(Step S907) For carrying out ordinary writing, when the priority-writing-quantity present value 308 is 0 (No in S902), the CPU 101 determines whether the number of ordinary vacant blocks is larger than a threshold value X (S907). Specifically, the vacant-block managing unit 114 of the CPU 101 refers to the physical-block management table 117b of the control information storage unit 117, counts the number of physical blocks of which the physical-block usage 304 is “vacant (ordinary)”, and compares the counted number with the threshold value X. The threshold value X is one of system information, e.g. 1 or above.

When the number of ordinary vacant blocks is larger than the threshold value X (Yes in S907), the CPU 101 proceeds to the processing of step S909, without carrying out the processing of step S908.

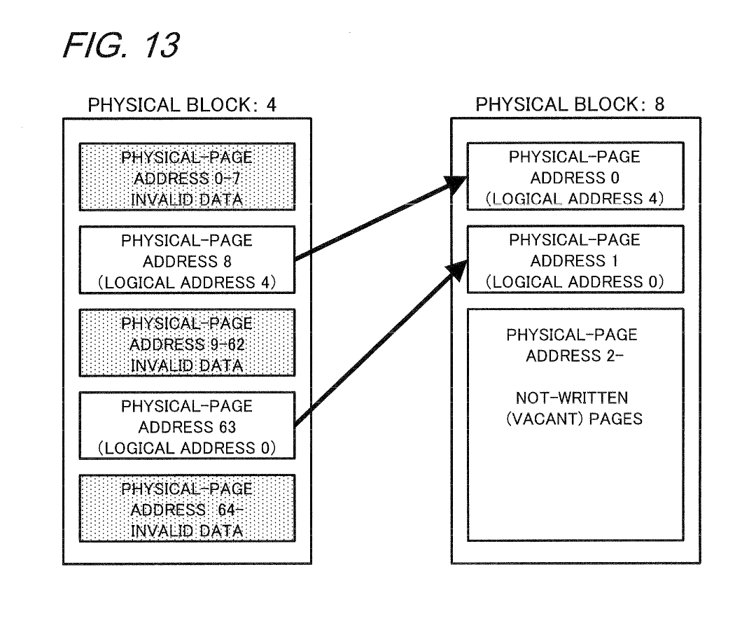

(Step S908) On the other hand, when the number of ordinary vacant blocks is equal to or smaller than the threshold value X (No in S907), in the CPU 101, the vacant-block managing unit 114 executes garbage collection processing (S908). The garbage collection processing is processing of increasing a vacant region for carrying out new writing by arranging data stored in the nonvolatile memory 120. The vacant region is a vacant block, or a not-written (vacant) page within a physical block. Hereinafter, as an example, garbage collection processing for generating one vacant block per one time will be described. Garbage collection processing in step 3908 will be described with reference to FIG. 13.

FIG. 13 shows an operation example of the garbage collection processing in step S908. The vacant-block managing unit 114 refers to the physical-block management table 117b of the control information storage unit 117, and selects a physical block of which the valid-data page number 305 is minimum out of physical blocks of which the physical-block usage 304 is “data”, for example. In the example in FIG. 13, a physical block of the physical-block address “4” of which the valid-data page number 305 is “2” is selected from the physical-block management table 117b in the state shown in FIG. 3. In the physical block of the physical-block address “4”, the total number of pages is 256, the valid-data page number 305 is “2”, and the not-written (vacant) page number 306 is “0” (FIG. 3). Therefore, it can be understood that 254 (=256-0-2) pages included in the physical block are the pages in which invalid data is recorded.

Further, the vacant-block managing unit 114 refers to the physical-block management table 117b of the control information storage unit 117, and selects one vacant block from physical blocks each of which the physical-block usage 304 is “vacant (ordinary)”, that is, the ordinary vacant blocks. In the example in FIG. 13, a physical block of the physical-block address “8” is selected.

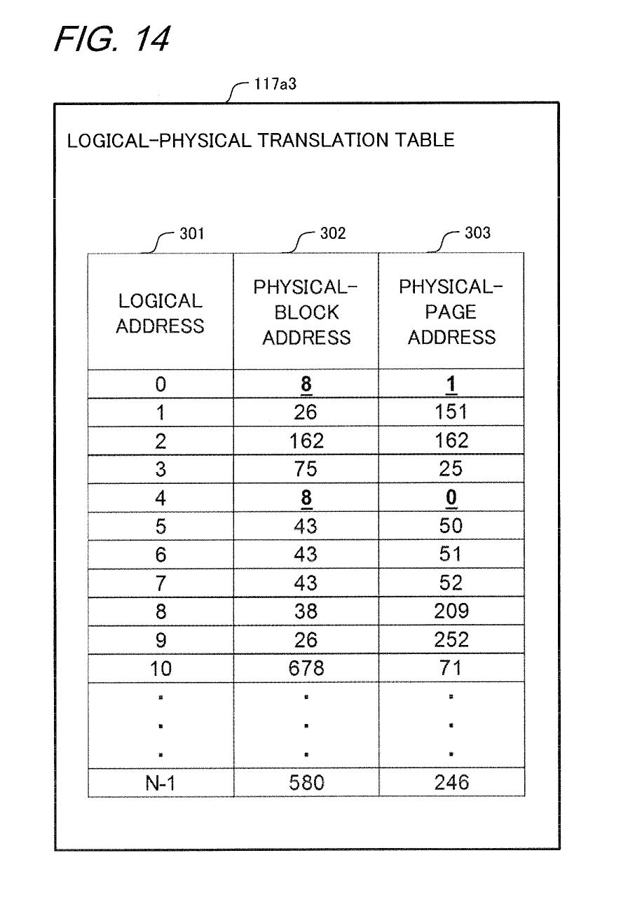

As shown in FIG. 13, the vacant-block managing unit 114 copies valid data (by two pages) existing in the physical block of a former (physical-block address “4”) to a vacant page of a latter (physical-block address “8”). Further, the vacant-block managing unit 114 erases the physical block of the former (physical-block address “4”), and sets the physical-block usage 304 to “vacant (ordinary)” (refer to FIG. 15). The erasing of the physical block of the physical-block address “4” includes erasing of the two pages in which recorded data is the copied valid data to the other physical block and erasing of the 254 pages in which recorded data is the invalid data, so that total 256 pages became “not written (vacant)”. FIGS. 14 and 15 illustrate the information after the garbage collection processing in step S908.

FIG. 14 shows an example of a logical-physical translation table 117a3 after the garbage collection processing, the logical-physical translation table 117a3 being changed from the state shown in FIG. 2. In the logical-physical translation table 117a3 after the garbage collection processing, the data of the logical addresses “0” and “4” shift from the physical-block address “4” set before the garbage collection processing (FIG. 2) to the physical-block address “8” as shown in FIG. 14.

FIG. 15 shows an example of a physical-block management table 117b3 after the garbage collection processing, the physical-block management table 117b3 being changed from the state shown in FIG. 3. In the physical-block management table 117b3 after the garbage collection processing, the physical-block usage 304 of the physical-block address “4” is updated from “data” set before the garbage collection processing (FIG. 3) to “vacant (ordinary)” as shown in FIG. 15. Further, regarding the physical-block address “4” set before and after the garbage collection processing, the valid-data page number 305 is updated from “2” to “0”, and the not-written (vacant) page number 306 is updated from “0” to “256”.

Further, the physical-block usage 304 of the physical-block address “8” is updated from “vacant (ordinary)” set before the garbage collection processing (FIG. 3) to “in-writing” as shown in FIG. 15. Further, regarding the physical-block address “8” before and after the garbage collection processing, the valid-data page number 305 is updated from “0” to “2”, and the not-written (vacant) page number 306 is updated from “256” to “254”. Therefore, a total number of vacant pages 306 in the two physical blocks for the garbage collection processing in step S908 increases from “256 (=0+256)” to “510 (=256+254)”.

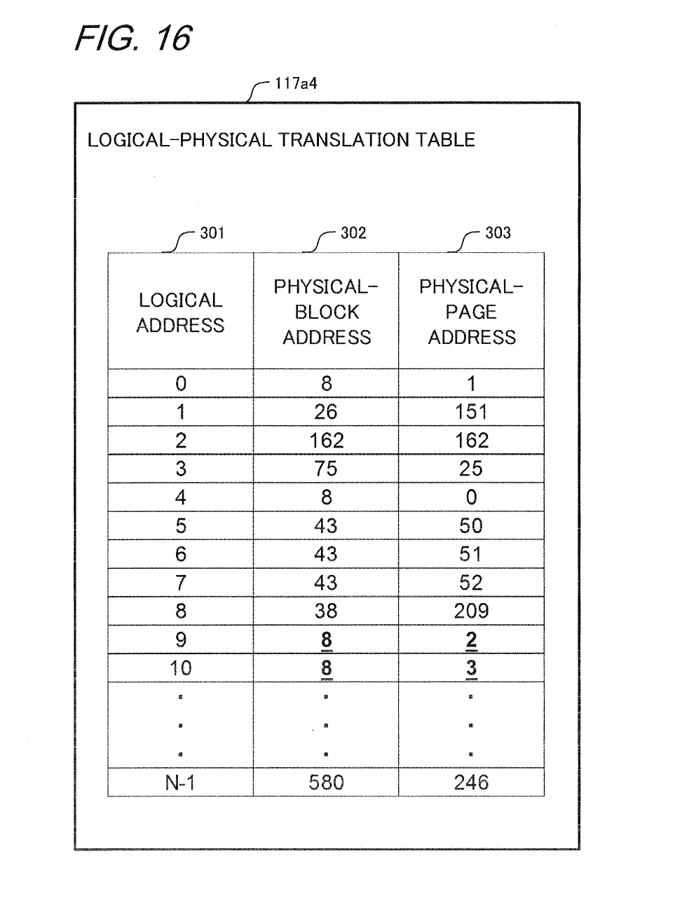

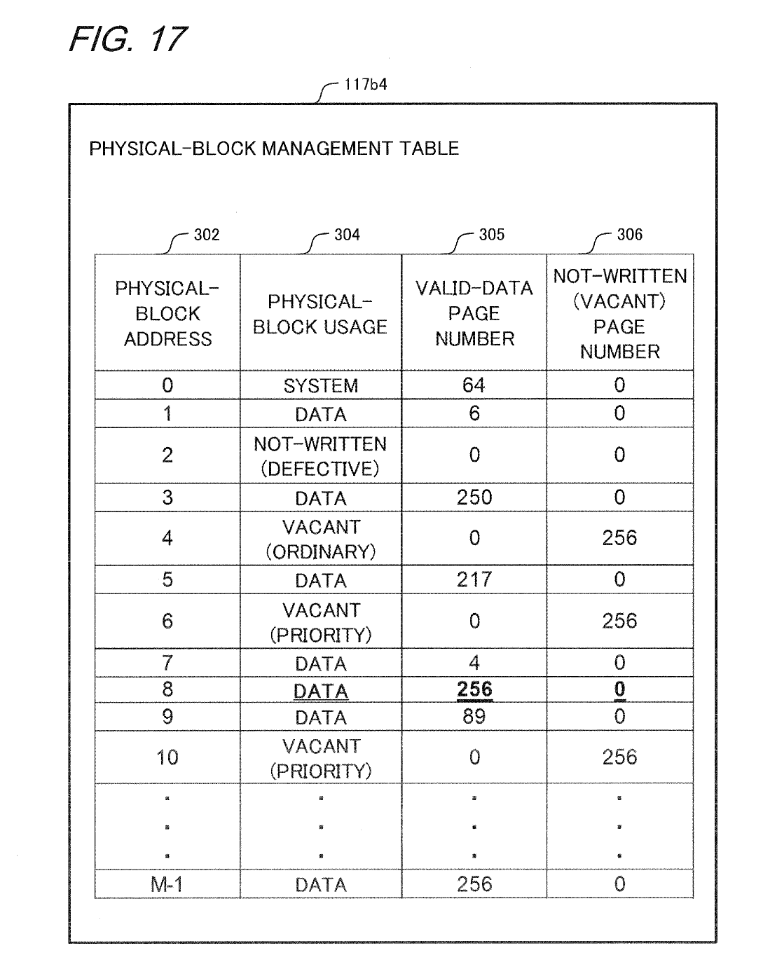

(Step S909) Referring back to FIG. 9, in the CPU 101, the vacant-block managing unit 114 then refers to the physical-block management table 117b3 of the control information storage unit 117, and selects a physical block of a writing destination (S909). When there is a physical block of which the physical-block usage 304 is “in-writing”, as is the case of the physical block of the physical-block address “8” in the example in FIG. 15, the vacant-block managing unit 114 selects such a physical block. On the other hand, when there is no physical block of which the physical-block usage 304 is “in-writing”, the vacant-block managing unit 114 selects one of physical blocks of which the physical-block usage 304 is “vacant (ordinary)”.
(Step S910) Next, in the CPU 101, the writing control unit 112 writes the writing data from the host device 200 received via the host interface unit 111, into the physical block selected in step S909 (S910). In the case where the logical address of 256 segments is received in step S901 as above, when the physical block of the physical-block address “8” in the example in FIG. 15 is selected in step S909, the not-written (vacant) page number is only 254. In such a case, the writing control unit 112 writes data into 254 segments, leaving two segments unwritten, out of 256 segments (S910), and proceeds to step S911. Writing of the remaining two segments is carried out by repeating the processing of and after step S901.
(Step S911) Next, in accordance with the writing in step S910, the writing control unit 112 of the CPU 101 updates the logical-physical translation table 117a3 and the physical-block management table 117b3 of the control information storage unit 117 (S911). FIGS. 16 and 17 illustrate the information updated in step S911.

FIG. 16 shows an example of a logical-physical translation table 117a4 updated from the state shown in FIG. 14. As illustrated in FIG. 16, the logical-physical translation table 117a4 are updated so as to correlate the physical-page addresses “2”, “3”, and subsequent addresses of the physical-block address “8” written in step S910 with the logical addresses “9”, “10”, and subsequent addresses received in step S901.

FIG. 17 shows an example of a physical-block management table 117b4 updated from the state shown in FIG. 15. In the updated physical-block management table 117b4 illustrated in FIG. 17, the physical-block usage 304 of the physical-block address “8” written in step S910 is updated from “in-writing” to “data”. Further, the valid-data page number 305 of the physical-block address “8” is updated from “254” to “0”.

Referring back to FIG. 9, after the writing control unit 112 carries out processing of step S911, the CPU 101 proceeds to processing of step S906. For example, when 254 segments are written out of 256 segments in step S910 and the two segments are remained as described above, the CPU 101 proceeds to “No” in step S906, and repeats the processing of step S901 and following steps.

When the whole writing assigned by the host device 200 is completed (Yes in S906), the processing of the present flowchart (step S803 in FIG. 8) ends and the process returns to step S802 in FIG. 8.

According to the above processing, when the present value of the priority-writing quantity is larger than 0 (S902), priority-writing, causing no garbage collection processing, is carried out by using a priority-writing vacant block (S903 to S905). Execution of the garbage collection processing is limited to the case where the present value of a priority-writing quantity is equal to or smaller than 0 and the ordinary physical block corresponds to the predetermined condition (No in S907). Consequently, data writing of a priority-writing quantity can have priority over garbage collection processing.

In the above description, in step S902, the priority-writing-quantity control unit 113 determines whether the priority-writing-quantity present value 308 is larger than 0, but the determination in step S902 is not limited to this method. For example, the determination in step S902 may be made using a predetermined value larger than 0 as a determination criterion.

### [1-2-2-3. Priority-Writing-Quantity Increasing Processing]

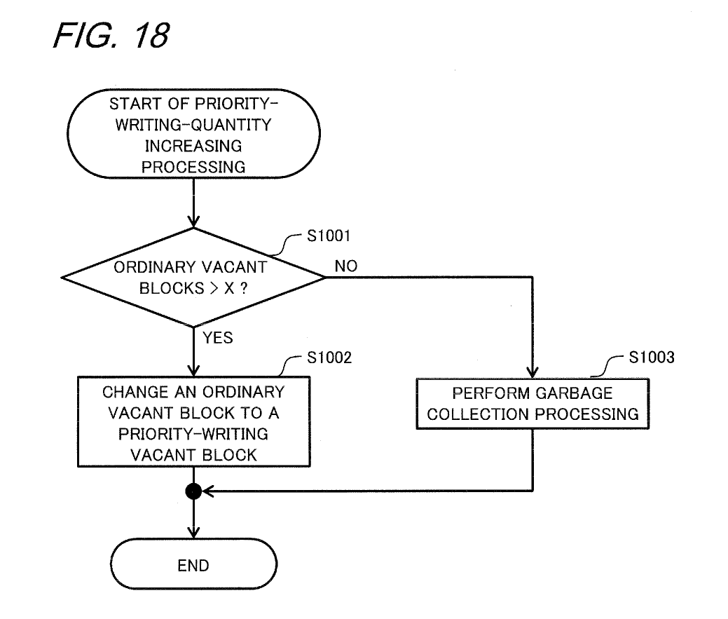

Next, a detail of the priority-writing-quantity increasing processing in step S805 in FIG. 8 will be described with reference to FIGS. 18 to 20.

FIG. 18 is a flowchart showing priority-writing-quantity increasing processing of the nonvolatile storage device 100 according to the present embodiment.

In the following description, it is assumed that, at a starting time of the operation of the present flowchart, the logical-physical translation table 117a is in the state shown in FIG. 2, the physical-block management table 117b is in the state shown in FIG. 3, and the priority-writing quantity information 117c is in the state shown in FIG. 4.

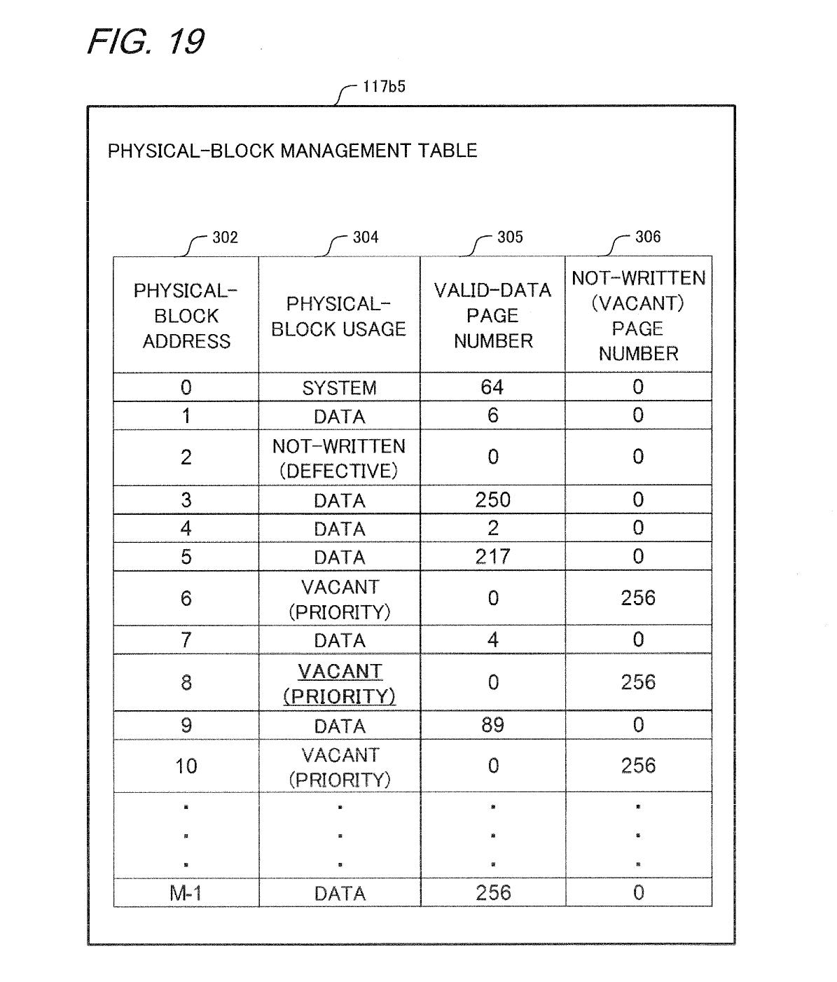

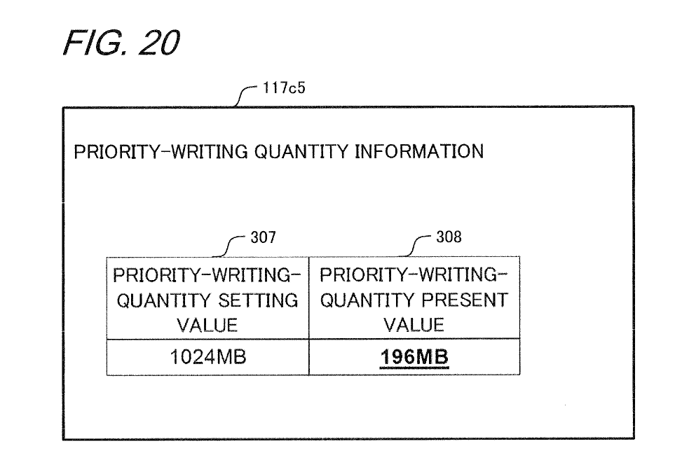

(Step S1001) First, the CPU 101 of the memory controller 110 determines whether the number of ordinary vacant blocks is larger than the threshold value X (S1001). Specifically, in the CPU 101, the vacant-block managing unit 114 refers to the physical-block management table 117b of the control information storage unit 117, counts the number of physical blocks of which the physical-block usage 304 is “vacant (ordinary)”, and compares the counted number with the threshold value X.
(Step S1002) When the number of ordinary vacant blocks is larger than the threshold value X (Yes in S1001), the CPU 101 changes one of the ordinary vacant blocks to a priority-writing vacant block (S1002). Specifically, in the CPU 101, the priority-writing-quantity control unit 113 refers to the physical-block management table 117b of the control information storage unit 117, and updates one of physical blocks of which the physical-block usage 304 is “vacant (ordinary)” to “vacant (priority)”. Further, at each time of updating one physical block from “vacant (ordinary)” to “vacant (priority)”, the priority-writing-quantity control unit 113 increases the priority-writing-quantity present value 308 of the priority-writing quantity information 117c of the control information storage unit 117 by 4 MB as a size of one physical block. FIGS. 19 and 20 illustrate the information updated in step S1002.

FIG. 19 shows an example of a physical-block management table 117b5 after the physical block of the physical-block address “8” is updated from the state shown in FIG. 3 by the priority-writing-quantity increasing processing. In the updated physical-block management table 117b5, the physical-block usage 304 of the physical-block address “8” is updated from “vacant (ordinary)” set before the updating (FIG. 3) to “vacant (priority)” as shown in FIG. 19.

FIG. 20 shows an example of priority-writing quantity information 117c5 after the physical block of the physical-block address “8” is updated from the state shown in FIG. 4 by priority-writing-quantity increasing processing. In the updated priority-writing quantity information 117c5, the value of the priority-writing-quantity present value 308 is updated from “192 MB” set before the updating (FIG. 4) to “196 MB” as shown in FIG. 20, which is an increase of one physical block (4 MB).

(Step S1003) Referring back to FIG. 18, when the number of ordinary vacant blocks is equal to or smaller than the threshold value X (No in S1001), in the CPU 101, the vacant-block managing unit 114 executes garbage collection processing to increase one priority-writing vacant block (S1003). In the garbage collection processing of step S1003, the processing similar to step S908 is performed. Further, the garbage collection processing (S1003) is suspended when a command is received from the host device 200. A detail of the garbage collection processing in step S1003 will be described later.

After completing the processing of step S1002 or step S1003, the CPU 101 ends the processing of the present flowchart (step S805 in FIG. 8), and returns to step S802 in FIG. 8.

According to the above processing, during a period of no reception of a command (No in S802), repetition of the priority-writing-quantity increasing processing (S805) increases one priority-writing vacant block for each time. For example, a change from the ordinary vacant block to the priority-writing vacant block (S1002) is repeated until

<A> the priority-writing-quantity present value 308 becomes equal to or larger than the priority-writing-quantity setting value 307 (No in step S804), or

<B> the number of ordinary vacant blocks becomes equal to or smaller than the threshold value X (No in S1001), and thus the priority-writing vacant block is secured.

Further, when the number of ordinary vacant blocks becomes equal to or smaller than the threshold value X (No in S1001), the garbage collection processing (S1002) generates a priority-writing vacant block. The threshold value X to be used in the processing of step S1002 may be set independently from the threshold value X used in step S907 in FIG. 9.

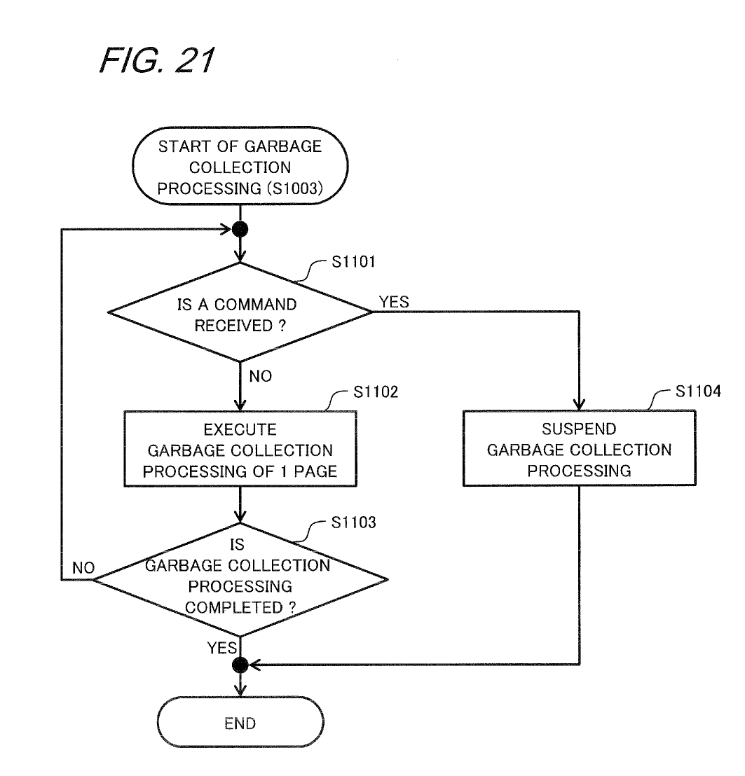

A detail of the garbage collection processing of step S1003 in the above processing will be described with reference to FIG. 21. Descriptions of the content similar to the content of the processing of step S908 will be omitted.

FIG. 21 is a flowchart illustrating the garbage collection processing in step S1003.

(Step S1101) First, the CPU 101 of the memory controller 110 determines whether the memory controller 110 is received a command from the host device 200, via the host interface unit 111 (S1101).
(Step S1102) When the CPU 101 determines that the memory controller 110 is not received a command from the host device 200 (No in S1101), the CPU 101 executes garbage collection processing of one page (S1102). For example, the CPU 101 writes data into an ordinary vacant block for copying one-page valid data.
(Step S1103) Next, the CPU 101 determines whether the garbage collection processing for generating one vacant block, for example, is completed (S1103). When the CPU 101 determines that the garbage collection processing of one vacant block is not completed (No in S1103), the CPU 101 returns to the processing of step S1101.

On the other hand, when the CPU 101 determines that the garbage collection processing of one vacant block is completed (Yes in S1103), the CPU 101 ends the processing of step S1003 in FIG. 18. In this case, in the CPU 101, the vacant-block managing unit 114 updates the physical-block-usage 304 of a new vacant block generated by the garbage collection processing, to “vacant (priority)”, in the physical-block management table 117b. Further, the vacant-block managing unit 114 increases, by one physical block, the priority-writing-quantity present value 308 of the priority-writing quantity information 117c.

(Step S1104) When the CPU 101 determines that the CPU 101 has received a command from the host device 200 (Yes in S1101), the CPU 101 suspends the garbage collection processing of step S1003 (S1104). In this case, the CPU 101 stores, into the RAM 118 or the like, information indicating, for example, an interruption position where the garbage collection processing is suspended, and prepares for subsequent restarting of the garbage collection processing from the suspended position.

When the garbage collection processing of step S1003 is suspended (S1104), the memory controller 110 ends the priority-writing-quantity increasing processing (step S805 in FIG. 8). In this case, the process proceeds to “Yes” in step S802 in FIG. 8, and the processing of step S803 is executed appropriately.

According to the above processing, when new command reception from the host device 200 is detected during the execution of the garbage collection processing in step S1003 (Yes in S1001), the priority-writing-quantity increasing processing is ended by quickly suspending or ending the garbage collection processing. Consequently, a command response time to the host device 200 can be prevented from becoming long.

### [1-2-2-4. Priority-Writing-Quantity Acquiring Operation]

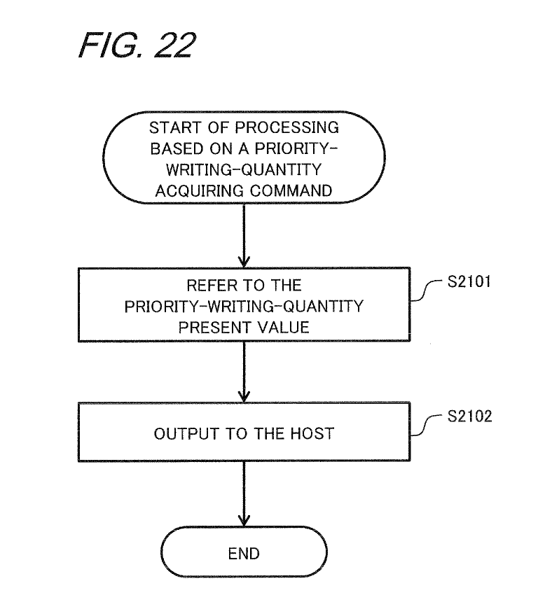

Next, a priority-writing-quantity acquiring operation will be described with reference to FIG. 22, which the nonvolatile storage device 100 carries out, in step S803 in FIG. 8, based on the priority-writing-quantity acquiring command from the host device 200.

FIG. 22 is a flowchart showing the priority-writing-quantity acquiring operation of the nonvolatile storage device 100 according to the present embodiment.

The operation of the present flowchart is started when, in step S802 in FIG. 8, the memory controller 110 of the nonvolatile storage device 100 receives the priority-writing-quantity acquiring command from the host device 200. The host device 200 issues the priority-writing-quantity acquiring command prior to writing content data into the nonvolatile storage device 100. The priority-writing-quantity acquiring command is for notifying the memory controller 110 of an instruction from the host device 200 for acquiring the priority-writing quantity.

(Step S2101) First, the host interface unit 111 of the memory controller 110 notifies the CPU 101 that the host interface unit 111 has received the priority-writing-quantity acquiring command. In the CPU 101, the priority-writing-quantity control unit 113 refers to the priority-writing quantity information 117c of the control information storage unit 117, and acquires a value of the priority-writing-quantity present value 308 (S2101).
(Step S2102) Next, by control of the CPU 101, the host interface unit 111 outputs to the host device 200 a value of the priority-writing-quantity present value 308 acquired in step S2101 (S2102).

After outputting the value of the priority-writing-quantity present value 308 to the host device 200 (S2102), the memory controller 110 ends the processing of the present flowchart (step S803 in FIG. 8), and returns to step S802 in FIG. 8.

According to the above processing, it enables the host device 200 to acquire a realtime value of the priority-writing-quantity present value 308 during the operation of the nonvolatile storage device 100.

### [1-2-2-5. Priority-Writing-Quantity Setting Operation]

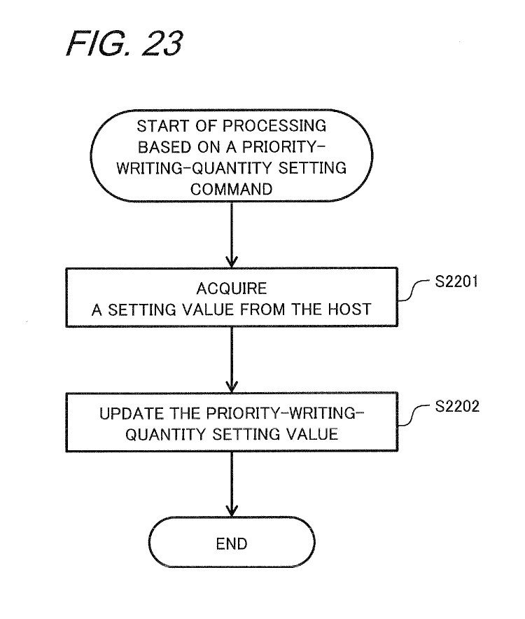

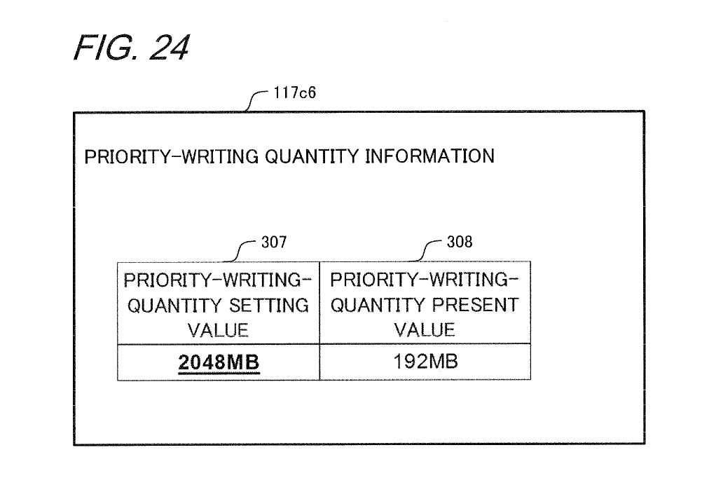

Next, a priority-writing-quantity setting operation will be described with reference to FIGS. 23 and 24, which the nonvolatile storage device 100 carries out, in step S803 in FIG. 8, based on the priority-writing-quantity setting command from the host device 200.

FIG. 23 is a flowchart showing the priority-writing-quantity setting operation of the nonvolatile storage device 100 according to the present embodiment.

The operation of the present flowchart is started when, in step S802 in FIG. 8, the memory controller 110 of the nonvolatile storage device 100 receives the priority-writing-quantity setting command from the host device 200. The host device 200 issues the priority-writing-quantity setting command in advance before the writing of content data into the nonvolatile storage device 100, e.g., at the time of turning on the power source of the nonvolatile storage device 100. The priority-writing-quantity setting command is for notifying the memory controller 110 of an instruction for setting a priority-writing quantity from the host device 200 by assigning a priority-writing quantity to be secured.

In the following description, it is assumed that at a starting time of the operation of the present flowchart, the priority-writing quantity information 117c is in the state shown in FIG. 4.

(Step S2201) First, the CPU 101 of the memory controller 110 acquires a setting value received from the host device 200 via the host interface unit 111 (S2201). The host interface unit 111 notifies the CPU 101 of the reception of the priority-writing-quantity setting command and the received setting value (for example, 2048 MB).
(Step S2202) Next, in the CPU 101, the priority-writing-quantity control unit 113 updates the priority-writing-quantity setting value 307 of the priority-writing quantity information 117c of the control information storage unit 117, to the value of the priority-writing quantity assigned by the host device 200. FIG. 24 illustrates priority-writing quantity information 117c6 updated in step S2202.

FIG. 24 shows an example of priority-writing quantity information 117c6 updated from the state shown in FIG. 4. In the updated priority-writing quantity information 117c6 illustrated in FIG. 24, the value of the priority-writing-quantity setting value 307 is updated from “1024 MB” before the updating (FIG. 4) to “2048 MB”.

After updating the priority-writing-quantity setting value 307 (S2202), the memory controller 110 ends the processing of the present flowchart (step S803 in FIG. 8), and returns to step S802 in FIG. 8.

According to the above processing, it enables the host device 200 to set the priority-writing-quantity setting value 307 that becomes a target quantity of the priority-writing vacant blocks to be achieved by the nonvolatile storage device 100.

### [1-2-3. Operation of Host Device]

Next, an operation of the host device 200 in the nonvolatile storage system 1 will be described.

[1-2-3-1. Operation after Power-On]

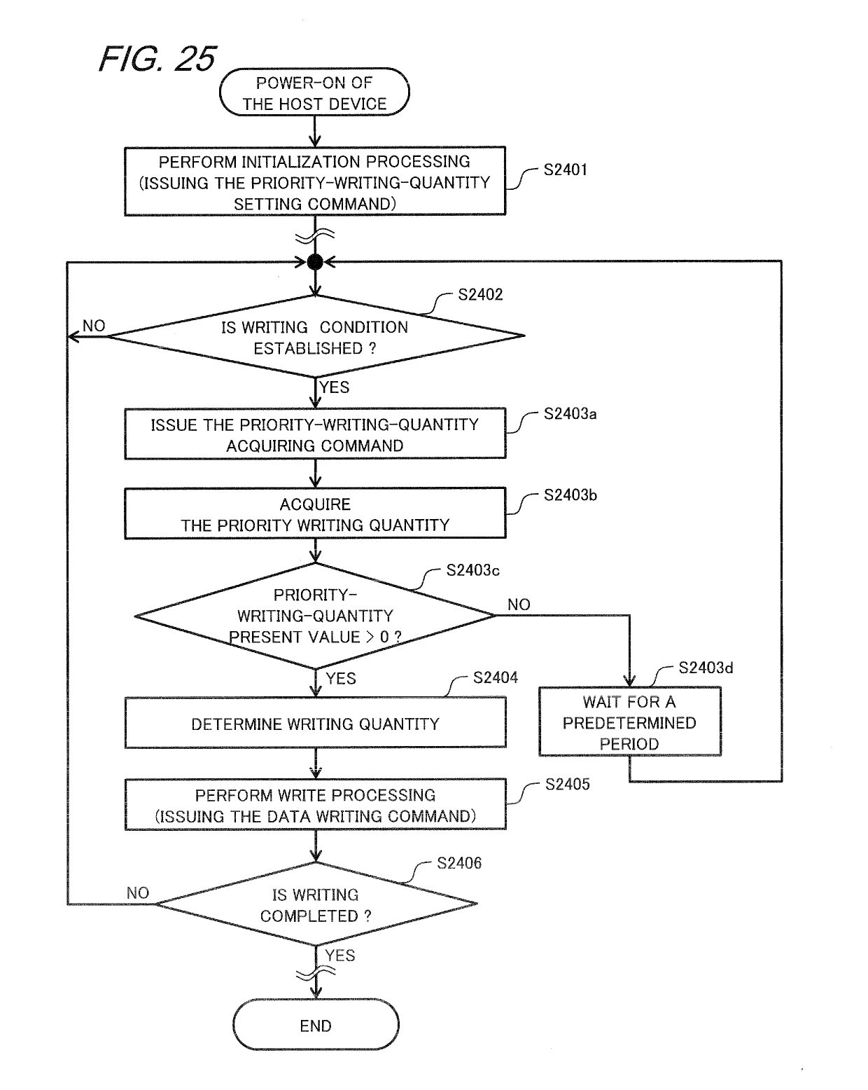

The operation of the host device 200 after a power source is turned on will be described with reference to FIG. 25.

FIG. 25 is a flowchart showing the operation of the host device 200 after the power-on according to the present embodiment.

(Step S2401) First, the host device 200 carries out initialization processing after the power source is turned on (S2401). Specifically, the CPU 211 of the host device 200 executes a program stored in the ROM 213, reads information stored in the storage unit 217, loads a program onto the RAM 212, and sets the memory interface unit 214, to set a state that various commands can be issued to the nonvolatile storage device 100.

In this case, the host device 200 determines in advance a necessary priority-writing quantity, and issues the priority-writing-quantity setting command to the nonvolatile storage device 100. For example, the host device 200 assigns, as the priority-writing quantity, a value larger than a writing unit per one time of content data, so that writing of the content data per one time can be expected as high-speed (that is, with priority).

In the present embodiment, it is assumed that a maximum size of content data written by the host device 200 is 1024 MB and that the host device 200 writes the content data in a unit of 4 MB. Further, it is assumed that, by expecting writing of one piece of content data at always a high speed, the host device 200 sets 1024 MB as the priority-writing quantity instructed by the priority-writing-quantity setting command.

Thereafter, the host device 200 carries out various kinds of processing triggered by the information of the input unit 215 and other units. When writing content data due to carrying out various kinds of processing, the host device 200 proceeds to the processing of step S2402.

(Step S2402) Next, the CPU 211 of the host device 200 determines whether a predetermined writing condition is established (S2402). The writing condition is a condition necessary for writing data into the nonvolatile storage device 100, and includes a condition that content data for writing is ready on the RAM 212 of the host device 200, for example. When the writing condition is not yet established (No in S2402), the CPU 211 of the host device 200 waits for the establishment of the writing condition.
(Step S2403a) When the writing condition is established (Yes in S2402), the host device 200 issues a priority-writing-quantity acquiring command to the nonvolatile storage device 100 (S2403a). In response to this issue, the memory controller 110 of the nonvolatile storage device 100 carries out the priority-writing-quantity acquiring operation (FIG. 22), and outputs a value of the priority-writing-quantity present value 308 to the host device 200.
(Step S2403b) Next, the host device 200 acquires the value of the priority-writing-quantity present value 308 of the nonvolatile storage device 100 via the memory interface unit 214, from the memory controller 110 of the nonvolatile storage device 100 (S2403b).
(Step S2403c) Next, the CPU 211 of the host device 200 determines whether the acquired value of the priority-writing-quantity present value 308 is larger than 0 (S2403c). For example, when the acquired value of the priority-writing-quantity present value 308 is 0, the host device 200 proceeds to step S2403d. The determination in step S2403c may be made using a predetermined value larger than 0, for example.
(Step S2403d) When the CPU 211 of the host device 200 determines that the acquired value of the priority-writing-quantity present value 308 is not larger than 0 (No in S2403c), the CPU 211 waits for a predetermined period (S2403d), and returns to step S2402. During the waiting period in step S2403d, the host device 200 may carry out another processing.
(Step S2404) On the other hand, when the CPU 211 of the host device 200 determines that the acquired value of the priority-writing-quantity present value 308 is larger than 0 (Yes in S2403c), the CPU 211 determines the writing quantity of the data writing command (S2404). Specifically, the CPU 211 compares the quantity of data prepared in the host device 200 with the value (quantity of data) of the priority-writing-quantity present value 308 acquired in step S2403a. Based on a result of the comparison, the CPU 211 determines a smaller data quantity as a quantity of writing data in this time.
(Step S2405) Next, the host device 200 writes data into the nonvolatile storage device 100 by issuing a data writing command having the determined writing quantity to the nonvolatile storage device 100 (S2405). Consequently, the nonvolatile storage device 100 carries out the data writing operation to write the prepared data by the data writing quantity determined in step S2404 (refer to FIG. 9).
(Step S2406) Next, the host device 200 determines whether the writing of the whole prepared data is completed (S2406). When the writing of the whole writing data is not completed (No in S2406), the host device 200 returns to the processing of step S2402, and carries out the processing of step S2402 and following steps regarding the remaining writing data.

On the other hand, when the writing of the whole writing data is completed (Yes in S2406), the host device 200 ends the writing processing.

By the above processing, the host device 200 according to the present embodiment acquires, prior to the writing of content data, the priority-writing-quantity present value 308 from the nonvolatile storage device 100, and adjusts the writing data quantity not to exceed the priority-writing-quantity present value 308 (S2403a to S2403d, and S2404). Consequently, the host device 200 according to the present embodiment can write data to the nonvolatile storage device 100 always at a high speed (that is, without causing the garbage collection processing). When the priority-writing-quantity present value 308 is in shortage, the host device 200 executes other processing without issuing a data writing command so that total efficiency of the nonvolatile storage system 1 can be optimized.

### [1-3. Effects and Others]

As described above, the memory controller 110 according to the present embodiment controls the nonvolatile memory 120 having the plurality of the physical blocks 121. The memory controller 110 includes the CPU 101 and the host interface unit 111. The CPU 101 writes data into the physical block 121. The host interface unit 111 is connected to a host device 200 and receives and transmits data from and to the host device 200. The CPU 101 manages the ordinary vacant blocks and the priority-writing vacant blocks based on the physical-block management table 117b for managing the states of the plurality of physical blocks 121. The ordinary vacant block is a physical block that can be used in garbage collection processing of arranging data stored in the nonvolatile memory 120. The priority-writing vacant block is a physical block that cannot be used in garbage collection processing. The CPU 101 increases the quantity of priority-writing vacant blocks (S805) when the CPU 101 does not receive the instruction from the host device 200. The CPU 101 writes data into the priority-writing vacant blocks (S904) when the CPU 101 receives a data writing instruction which is an instruction for writing data from the host device 200.

According to the memory controller 110, upon receiving the instruction for writing data into priority-writing vacant blocks which are increased and secured when not receiving an instruction from the host device 200, the memory controller 110 can write the data without carrying out garbage collection processing. Consequently, writing a predetermined quantity of data from the host device 200 can be carried out with priority.

In the present embodiment, when the CPU 101 does not receive the instruction from the host device 200, the CPU 101 increases the quantity of the priority-writing vacant blocks to the priority-writing-quantity setting value 307, based on the priority-writing quantity information 117c including the priority-writing-quantity setting value 307. Consequently, based on the priority-writing quantity information 117c, it enables to set a data quantity by which priority-writing is considered possible without generating garbage collection processing.

Further, in the present embodiment, the priority-writing quantity information 117c includes the priority-writing-quantity present value 308 as information expressing the present quantity of the priority-writing vacant blocks. When the CPU 101 receives a data writing instruction from the host device 200, the CPU 101 refers to the priority-writing quantity information (S902). When the priority-writing-quantity present value 308 is not equal to or smaller than a predetermined value (which is equal to or larger than 0 or the like), the CPU 101 writes data into the priority-writing vacant blocks (S903 to S904). When the priority-writing-quantity present value 308 is equal to or smaller than the predetermined value, the CPU 101 writes data using the ordinary vacant blocks (S909 to S910).

Consequently, it becomes possible to carry out priority-writing without causing garbage collection processing, as an upper limit is the priority-writing-quantity present value 308.

Further, in the present embodiment, when the priority-writing-quantity present value 308 is equal to or smaller than the predetermined value and also the ordinary vacant block meets a predetermined condition (equal to or smaller than the threshold value X) (No in S907), the CPU 101 executes garbage collection processing using the ordinary vacant block to generate a writable physical block (S908).

Consequently, generation of garbage collection processing can be restricted to the time when the ordinary vacant blocks are exhausted.

Further, in the present embodiment, when the CPU 101 receives an instruction from the host device 200 while carrying out the processing of increasing the quantity of priority-writing vacant blocks (S805), the CPU 101 suspends the processing of increasing the quantity of the priority-writing vacant blocks (S1103). Consequently, a situation of waiting for the instruction from the host device 200 can be avoided.

Further, in the present embodiment, the CPU 101 outputs, to the host device 200, a value of the priority-writing-quantity present value 308 as information regarding the priority-writing information, based on the instruction from the host device 200 (S2101 and S2102). Not only the value of the priority-writing-quantity present value 308, the priority-writing-quantity setting value 307, for example, may be output to the host device 200.

Further, in the present embodiment, the CPU 101 determines the priority-writing-quantity setting value 307, based on the value instructed from the host device 200 (S2201 and S2202). Consequently, it enables the host device 200 to control a state without causing garbage collection processing by setting the priority-writing-quantity setting value 307 that becomes a target increase quantity of priority-writing vacant blocks in the priority-writing-quantity increasing processing (S805).

Further, the nonvolatile storage device 100 in the present embodiment includes the memory controller 110 and the nonvolatile memory 120. The nonvolatile memory 120 is connected to the memory controller 110, and stores data written by the memory controller 110.

Further, the nonvolatile storage system 1 in the present embodiment includes the memory controller 110, the nonvolatile memory 120, and the host device 200. The host device 200 connects to the memory controller 110, and transmits an instruction to the memory controller 110 for writing data into the nonvolatile memory 120.

Further, in the present embodiment, the host device 200 acquires, from the memory controller 110, the priority-writing-quantity present value 308 as information indicating the quantity of priority-writing vacant blocks, and transmits writing data to the memory controller 110 (S2404). The quantity of writing data is equal to or smaller than the acquired priority-writing-quantity present value 308. Consequently, the host device 200 can instruct data writing so as not to cause garbage collection processing.

A memory control method according to the present embodiment is a method for controlling the nonvolatile memory 120 having the plurality of the physical blocks 121 by the memory controller 110. The present method includes managing the ordinary vacant blocks and the priority-writing vacant blocks based on the physical-block management table 117b for managing the states of the plurality of physical blocks. The memory controller 110 increases the quantity of priority-writing vacant blocks (S805), when the memory controller 110 does not receive the instruction from the host device 200. When the memory controller 110 receives the data writing instruction from the host device 200, the memory controller 110 writes data into the priority-writing vacant blocks (S904).

According to the above memory control method, writing the predetermined quantity of data from the host device 200 can be carried out with priority over garbage collection processing.

### Other Embodiments

The first embodiment is described above as an exemplification of the technique of the present disclosure. However, the technique in the present disclosure is not limited to the above, and can be also applied to embodiments after appropriately carrying out changes, modifications, replacements, additions, and omissions.

Thus, other embodiments will be exemplified below.

In the memory controller 110 and the host device 200 according to the first embodiment, various functional blocks may be individually arranged in one chip by semiconductor circuits such as large-scale integration (LSI) circuits, or may be arranged in one chip to include a part or a whole of the functional blocks. The semiconductor circuit may have a predetermined function realized by only a hardware configuration, or may have a predetermined function realized in cooperation with software. For example, the semiconductor circuit is configured with an application specific integrated circuit (ASIC), a field programmable gate array (FPGA), a central processing unit (CPU), a micro-processing unit (MPU), and a microcomputer.

The LSI referred to in the above description is also referred to as an integrated circuit (IC), a system LSI, a super LSI, or an ultra LSI, depending on a difference in integration. Further, an integrated circuit is not limited to be realized by an LSI but may be realized by an exclusive circuit or a general-purpose processor. The FPGA that can be programmed after manufacturing the LSI, and a reconfigurable processor capable of reconfiguring connection and setting of circuit cells inside the LSI may be also utilized.

The execution order of the processing method in the first embodiment is not necessarily limited to that described in the embodiment, and the execution order can be replaced within a range not deviating the essentials of the present disclosure.

The memory controller 110 according to the first embodiment, the nonvolatile storage device 100 including the memory controller 110 and the nonvolatile memory 120, the nonvolatile storage system 1 including the nonvolatile storage device 100 and the host device 200, the memory control method executed in the first embodiment, a computer program for causing a computer to execute the memory control method, and a computer-readable recording medium recorded with the program are all included in the scope of the present disclosure. Examples of the computer-readable recording medium may include a flexible disc, a hard disc, a compact disc read only memory (CD-ROM), a magneto-optical disc (MO), a digital versatile disc (DVD), a DVD-RM, a DVD-RAM, a Blu-ray (registered trade name) disc (BD), and a semiconductor memory.

The computer program is not limited to that recorded on the recording medium, but may be the program that can be transmitted via an electric communication line, a wireless or wired communication line, and a network represented by the Internet.

The embodiments are exemplified above as the technique in the present disclosure. For this purpose, the appended drawings and detailed descriptions are provided.

Therefore, the constituent elements described in the appended drawings and the detailed descriptions include not only constituent elements that are essential for solving the problem but also include constituent elements that are not essential for solving the problem, for the purpose of exemplifying the above technique. Accordingly, just because the not essential constituent elements are described in the appended drawings and the detailed descriptions, it should not be recognized that these not essential constituent elements are essential.

Because the above embodiments are for exemplifying the technique in the present disclosure, various changes, replacements, additions, and omissions can be carried out in claims or in the equivalent range.

### INDUSTRIAL APPLICABILITY

The present disclosure can be applied to a recording device which is built in with a nonvolatile memory for carrying out garbage collection processing. Specifically, the present disclosure can be applied to an SSD, a memory card, a flash drive, a memory device for incorporation, and the like.

1. A memory controller for controlling a nonvolatile memory having a plurality of physical block,
the memory controller comprising:
a control unit that writes data into the physical block; and
a host interface unit that is connected to an external device and receives and transmits data from and to the external device, wherein
the control unit manages first vacant blocks and second vacant blocks based on a physical-block management table for managing states of the plurality of physical blocks, the first vacant block being a physical block that can be used in garbage collection processing of arranging data stored in the nonvolatile memory, and the second vacant block being a physical block that cannot be used in the garbage collection processing,
the control unit increases a quantity of the second vacant blocks when the control unit does not receive an instruction from the external device, and
the control unit writes data into the second vacant block when the control unit receives an instruction for writing data from the external device.

2. The memory controller according to claim 1, wherein
when the control unit does not receive an instruction from the external device, the control unit increases the quantity of the second vacant blocks to a predetermined setting value based on priority-writing quantity information including the predetermined setting value.

3. The memory controller according to claim 2, wherein
the priority-writing quantity information comprises information indicating a present quantity of the second vacant blocks,
the control unit refers to the priority-writing quantity information when the control unit receives the instruction from the external device,
the control unit writes data into the second vacant blocks when the present quantity of the second vacant blocks is not equal to or smaller than the predetermined value, and
the control unit writes data using the first vacant blocks when the present quantity of second vacant blocks is equal to or smaller than the predetermined value.

4. The memory controller according to claim 3, wherein
when the present quantity of the second vacant blocks is equal to or smaller than a predetermined value and the first vacant blocks meet a predetermined condition, the control unit executes the garbage collection processing using the first vacant blocks to generate a writable physical block.

5. The memory controller according to claim 4, wherein
when the control unit receives an instruction from the external device while carrying out processing of increasing the quantity of second vacant blocks, the control unit suspends the processing of increasing the quantity of second vacant blocks.

6. The memory controller according claim 2, wherein
the control unit outputs information regarding the priority-writing quantity information to the external device, based on an instruction from the external device.

7. The memory controller according to claim 2, wherein
the control unit determines a setting value of the priority-writing quantity information, based on a value instructed from the external device.

8. A nonvolatile storage device comprising:
the memory controller according to claim 1; and
a nonvolatile memory connected to the memory controller and storing data written by the memory controller.

9. A nonvolatile storage system comprising:
the memory controller according to claim 1;
a nonvolatile memory connected to the memory controller and storing data written by the memory controller; and
an external device connecting to the memory controller and transmitting an instruction to the memory controller for writing data into the nonvolatile memory.

10. The nonvolatile storage system according to claim 9, wherein
the external device
acquires information indicating a quantity of second physical blocks from the memory controller, and
transmits writing data to the memory controller, the quantity of writing data being equal to or smaller than the quantity of the second physical blocks indicated by the acquired information.

11. A memory control method for controlling a nonvolatile memory having a plurality of physical blocks by the memory controller,
the memory control method comprising:
managing first vacant blocks and second vacant blocks based on a physical-block management table for managing states of the plurality of physical blocks, the first vacant block being a physical block that can be used in garbage collection processing of arranging data stored in the nonvolatile memory, and the second vacant block being a physical block that cannot be used in the garbage collection processing;
increasing the quantity of second vacant blocks when the memory controller does not receive an instruction from an external device; and
writing data into the second vacant blocks when the memory controller receives an instruction for writing data from the external device.
